(19) United States
(12) Patent Application Publication
(10) Pub. No.: US 2026/0146671 A1
(43) Pub. Date: May 28, 2026

(54) SYSTEM AND METHOD FOR AUTOMATICALLY SENSING A POSITION OF A PACKING LOADING ASSEMBLY WITH A POSITION SENSOR

(71) Applicant: A.W. CHESTERTON COMPANY, Groveland, MA (US)

(72) Inventors: Michael P. GRIMANIS, Wayland, MA (US); Milan ARDELJAN, Dover, NH (US); Robert James POWERS, Salem, MA (US); Ron HART, Middleton, MA (US)

(21) Appl. No.: 19/454,158

(22) Filed: Jan. 20, 2026

Related U.S. Application Data
(63) Continuation-in-part of application No. 19/230,939, filed on Jun. 6, 2025.
Application No. 19/230,939 is a continuation of application No. 18/499,889, filed on Nov. 1, 2023, now Pat. No. 12,331,836.
Application No. 18/499,889 is a continuation-in-part of application No. 16/850,688, filed on Apr. 16, 2020, now abandoned.
(60) Provisional application No. 62/835,966, filed on Apr. 18, 2019.
(60) Provisional application No. 63/421,300, filed on Nov. 1, 2022.
(60) Provisional application No. 63/746,806, filed on Jan. 17, 2025.

(51) Int. Cl. F16J 15/40; F16J 15/00; F16J 15/06; F16J 15/14; F16J 15/18; F16J 15/34; F16J 15/46; F16J 15/56; F16K 31/02; F16K 31/42; G05D 16/00; G05D 16/20

(52) U.S. Cl. CPC F16J 15/40; G06F 16/285; F16J 15/002; F16J 15/067; F16J 15/14; F16J 15/185; F16J 15/3448; F16J 15/3492; F16J 15/46; F16J 15/56; F16K 31/02; F16K 31/42; G05D 16/024; G05D 16/20

(57) ABSTRACT

A system for monitoring an axial biasing force applied to a packing assembly having a packing loading assembly for sealing a process fluid within stationary equipment and for applying the axial biasing force to the packing assembly via a pressurized fluid from a fluid source. The packing loading assembly has a gland element for coupling to the stationary equipment and an external actuation subsystem for applying an axial actuation force directly to the gland element in response to the pressurized fluid. The gland element in response to the axial actuation force applies the axial biasing force to the packing assembly. The external actuation subsystem has a stationary component and a movable component coupled to the gland element. The system also includes a sensor assembly having a position sensor coupled to the external actuation subsystem for monitoring movement of the movable component relative to the stationary component.

### RELATED APPLICATIONS

The present application claims priority to provisional patent application Ser. No. 63/746,806, filed on Jan. 17, 2025, and entitled System And Method For Automatically Energizing Packing Material With A Packing Loading Assembly Employing a Position Sensor, and claims priority to and is a continuation-in-part patent application of U.S. patent application Ser. No. 19/230,939, filed on Jun. 6, 2025, and entitled System And Method For Automatically Energizing Packing Material With A Packing Loading Assembly, which is in turn a continuation of U.S. patent application Ser. No. 18/499,889, filed on Nov. 1, 2023, and entitled System And Method For Automatically Energizing Packing Material With A Packing Loading Assembly, now U.S. Patent No., 12,331,836, which claims priority to U.S. provisional application Ser. No. 63/421,300, filed on Nov. 1, 2022, and entitled System And Method For Automatically Energizing Packing Material With A Packing Loading Assembly, and which is in turn a continuation-in-part patent application of abandoned U.S. patent application Ser. No. 16/850,688, filed on Apr. 16, 2020, and entitled System And Method For Automatically Energizing Packing Material With A Packing Loading Assembly, which claims priority to U.S. provisional patent application Ser. No. 62/835,966, filed on Apr. 18, 2019, and entitled method And System For Automatically Energizing Packing Material In A Mechanical Seal, the contents of all of the foregoing are herein incorporated by reference.

### BACKGROUND OF THE INVENTION

The present invention relates to packing material in a stationary equipment, and more specifically relates to a system and method for automatically sensing compression or position of a packing loading assembly.

In some mechanical fields, it is important that a fluid tight seal be effected between adjacent pieces of equipment. For example, one common application of sealing technology relates to a spinning or rotating shaft having a process medium or fluid housed at one end. In such a situation, it is typically desirable to prevent the process fluid from leaking from around the shaft. Accordingly, as is known, stationary equipment, such as a stuffing box, is employed to surround the shaft. The stuffing box can employ a packing material, oftentimes referred to as a compression packing seal or packing assembly, which is wrapped around the rotating shaft and provides an interface and sealing surface between the rotating shaft and the stuffing box. The compression packing seal is typically composed of a series of stacked, axially abutting packing rings. A mechanical seal can also be employed to help effectuate shaft sealing by being mounted to the stuffing box instead of the packing material or alternatively the packing material can be incorporated into the mechanical seal.

The compression packing seal may be in the form of a braided packing material that is commonly square or round when viewed in cross section, although the compression packing seal may be provided in a variety of cross-sectional shapes. The compression packing seal may be cut to an appropriate size and wrapped around the shaft to form a ring. Multiple packing rings may be provided along the length of the shaft in order to provide a seal around the shaft. Suitable structure, such as a gland element, can be used to secure and compress the compression packing rings inside the stuffing box. When compressed, the packing assembly expands radially to create a seal between the rotating shaft and the stationary stuffing box to help minimize fluid leakage from around the shaft. The seal formed by the compression packing seal forms a fluid seal and maintains a pressure boundary between the fluid inside the stuffing box and the external atmosphere. The gland element is typically tightened using suitable bolts to apply a selected compressive force to the compression packing seal.

The compression packing seal is characterized by a simple and robust construction that facilitates installation and removal without requiring decoupling or disassembly of the drive shaft or associated rotating equipment, thereby reducing downtime and simplifying retrofit into existing pump systems. The compression packing seal traditionally requires periodic adjustment of the gland element to maintain a desired compressive load on the packing elements and to ensure acceptable sealing performance. A controlled degree of leakage is inherent to and acceptable for compression packing seals, and in many applications is desirable to provide lubrication and thermal management of the packing material and the shaft or sleeve surface. The compression packing seal further provide versatility, including suitability for sealing high-viscosity and particulate-laden fluids and operation without a practical upper viscosity limit.

A drawback of the conventional mounting techniques for the packing material is that the sealing ability of the packing material degrades over time. As such, an ever-increasing amount of compression must be applied to the packing material in order to maintain the fluid seal.

In order to address this issue, conventional systems try to apply an axial force to the packing material to form and maintain the fluid seal between the stuffing box and the shaft. According to one conventional technique, known structure, such as gland bolts, can be used to apply the axial loading force to the packing material. As the packing material wears over time, however, the axial load on the packing material decreases and leakage occurs, so gland bolt adjustments are required on a regular basis.

### SUMMARY OF THE INVENTION

The present invention automates and optimizes the required attention needed to properly operate and maintain mechanical packing in mechanical equipment, such as a pump. The automated measurement and adjustment system of the present invention allows for the operation of mechanical packing and the ability to accurately determine any remaining that are left or available in the deployed packing material. As such, the system of the present invention can determine the amount of time remaining before the mechanical packing needs to be replaced. The present invention provides broad advantages over current technology by minimizing intervention and oversight by personnel while concomitantly allowing personnel to remain safely distant from moving equipment (e.g., rotating pump shafts). The system can employ one or more position sensors to help measure packing material movement distance to determine the rate of consolidation of the mechanical packing and project the required maintenance timelines. The system can also employ or utilize other types of data as well, such as temperature, pressure and vibration.

The pressure regulating system of the present invention can employ any selected combination of any of the foregoing elements, units, assemblies, or subassemblies.

The present invention is directed to a system for monitoring an axial biasing force applied to a packing assembly having a plurality of packing elements mounted within stationary equipment. The system includes a packing loading assembly for sealing a process fluid within the stationary equipment and for applying the axial biasing force to the packing assembly via a pressurized fluid from a fluid source. The packing loading assembly has a gland element for coupling to the stationary equipment, and an external actuation subsystem for applying an axial actuation force directly to the gland element in response to the pressurized fluid, and wherein the gland element in response to the axial actuation force applies the axial biasing force to the packing assembly. The external actuation subsystem has a stationary component and a movable component coupled to the gland element. The system also includes a sensor assembly having a position sensor coupled to the external actuation subsystem for monitoring movement of the movable component relative to the stationary component.

The position sensor measures a relative movement between the stationary component and the movable component and generates in response thereto sensor data indicative of a physical state, position, or movement of one or more packing elements of the packing assembly. The sensor data includes packing related data that can be correlated to an amount of compression applied to the packing assembly. The packing related can also be correlated to an amount of compression remaining to be applied to the packing assembly or a remaining amount of useful life in the packing assembly.

The sensor assembly includes a main housing having a first main housing component and a second main housing component where at least one of the first and second main housing components can move axially relative to the other. The first main housing component has an open end forming a first chamber and an opposed closed end, and the second main housing component forms a second chamber for mounting the position sensor. The second main housing component is sized and configured to seat within a portion of the first chamber, and the first main housing component moves axially relative to the second main housing component in a telescoping manner. The second main housing component has a first groove formed in an outer surface for seating a first sealing element, and the first sealing element forms a seal between an inner surface of the first main housing component and the outer surface of the second main housing component. The position sensor can be a time-of-flight (TOF) sensor configured to generate and emit a radiation beam. The closed end of the first main housing component has disposed therein an optical element formed of an optically transmissive material for reflecting back the radiation beam to form a reflected beam. The TOF sensor can be configured to detect the reflected beam which forms part of the sensor data. The second end of the first main housing component can be configured to include an air vent that communicates with the first chamber.

A securing assembly can be provided for securing the sensor assembly to the external actuation subsystem. The securing assembly can include a first bracket element for coupling the first main housing component to the movable component of the external actuation subsystem, and a second bracket element for coupling the second main housing component to the stationary component of the external actuation subsystem. The sensor assembly can also include a protective optical element disposed adjacent to the position sensor to provide optical conditioning and environmental protection to the position sensor. The protective optical element is formed from or is coated with polytetrafluoroethylene (PTFE) configured to provide diffuse reflection characteristics. The sensor data includes one or more of an absolute distance measurement between the position sensor and a target surface of the first chamber, incremental displacement values of the first main housing component, direction of movement of the first main housing component, a rate of position change over time of the first main housing component, a signal strength, a timestamp, and temperature within the second chamber.

The system can also include an electronic device disposed in communication with the position sensor that has a processor configured to receive the sensor data from the position sensor, determine a compression state of the packing elements based on the sensor data, determine a remaining compression capacity of the packing elements based on the sensor data, and generate an output indicative of at least one of the compression state and the remaining compression capacity. The electronic device can also have a storage element for storing one or more control applications and a processor for processing the sensor data and for applying thereto the control application to determine one or more parameters associated with the packing assembly. According to other embodiments, the electronic device can be configured to generate a user interface displaying at least one of a current compression value, a remaining adjustment capacity, and a predicted time to replacement of the packing elements.

The gland element can include a top portion having a top surface for contacting a bottom surface of the external actuation subsystem and a bottom flange portion that has a surface that contacts an axially outermost one of the packing elements for applying the axial biasing force thereto.

The present invention is also directed to a method of monitoring and predicting maintenance requirements for a packing loading assembly having a plurality of packing elements and a movable component configured to apply compression to the plurality of packing elements, the method comprising coupling a sensor assembly to the packing loading assembly, wherein the sensor assembly includes a position sensor configured to measure a position of the movable component relative to a stationary reference; generating sensor data with the position sensor over time, the sensor data being indicative of progressive movement of the movable component;
transmitting the sensor data to an electronic device; processing the sensor data with the electronic device to determine a current compression state of the packing elements and a remaining compression capacity; analyzing historical sensor data with a machine learning model model to estimate a remaining useful life of the packing elements; and generating a maintenance output indicating at least one of: the current compression state, the remaining compression capacity, and the estimated remaining useful life.

According to the method, the analyzing the historical sensor data can include applying the machine learning model to extrapolate a compression-versus-time relationship and to predict a future time at which a maximum compression limit is reached, and the analyzing the historical sensor data can include applying a reliability engineering model to estimate a time-dependent hazard rate for the packing elements. The method also includes generating an alert when at least one of the remaining compression capacity and the estimated remaining useful life falls below a predetermined threshold.

The present invention is also directed to a sensor assembly for monitoring a packing loading assembly having packing elements and a loading component movable between a preloaded position and a loaded position to apply compression to the packing elements. The sensor assembly includes a first main housing component coupled to the loading component and configured to move with the loading component; a second main housing component coupled to a stationary reference and configured to remain stationary relative to the loading component, wherein the first main housing component and the second main housing component are configured for telescoping movement relative to each other along an axial direction; a position sensor mounted within the second housing component and configured to measure a distance to a target surface associated with the first housing component; and a securing assembly configured to attach the first housing component to the loading component and to attach the second housing component to the stationary reference.

The position sensor can include an optical time-of-flight (TOF) sensor configured to emit an optical signal toward the target surface and to determine the distance based on a propagation time of a radiation beam generated by the TOF sensor. The target surface can include an optical element positioned at an end of the first housing component and configured to reflect the radiation beam emitted by the position sensor. The optical element can include or be formed of or be coated with polytetrafluoroethylene (PTFE) configured to provide diffuse reflection characteristics. The first main housing component has a chamber and the second housing component is configured to slide telescopically within the chamber of the first housing component. One or more sealing elements can be disposed between the first main housing component and the second housing component to form a seal therebetween. The first main housing component can include an air vent configured to allow air to enter and exit the chamber during relative movement of the first and second main housing components.

The present invention is directed to a pressure regulating system for use with a packing loading assembly and stationary equipment for applying a substantially uniform force or load to a stacked set of packing elements. The force applied to the packing elements can be regulated or controlled in real time and in a remote manner. The packing loading assembly includes a gland and an axially movable follower element that can be energized by pressurized fluid to move between a pre-loaded position where the follower element does not apply an axial load to the packing elements to a loaded position where the follower element applies the axial load to the packing elements. The axial load energizes the packing elements to form a fluid tight seal between the shaft or associated sleeve element and the packing elements, as well as between the packing elements and selected surfaces of the stationary equipment.

According to one practice, the present invention is directed to a pressure regulating system for stationary equipment employing a stacked set of packing elements, comprising a fluid source for supplying a source of fluid, a pressure regulator for regulating the pressure of the fluid to form a pressurized fluid, and a packing loading assembly for sealing a process fluid within the stationary equipment and for applying an axial loading force to the packing elements via the pressurized fluid from the pressure regulator. The pressure regulator has an inlet for receiving the fluid from the fluid source and an outlet for supplying the pressurized fluid.

The pressure regulating system can also include a fluid regulator disposed between the fluid source and the pressure regulator for regulating the fluid flow therebetween. The fluid regulator can be a check valve.

The present invention is directed to a system for regulating an axial biasing force applied to a stacked set of packing elements mounted within stationary equipment, comprising a fluid source for supplying a source of fluid, a pressure regulator for regulating the pressure of the fluid to form a pressurized fluid, and a packing loading assembly for sealing a process fluid within the stationary equipment and for applying the axial biasing force to the packing elements via the pressurized fluid from the pressure regulator. The packing loading assembly includes a gland element for mounting to the stationary equipment by a plurality of gland bolts, and an external actuation subsystem for coupling to at least one of the plurality of gland bolts for applying an axial actuation force directly to the gland element in response to the pressurized fluid, and wherein the gland element in response to the axial actuation force applies the axial biasing force to the packing elements.

The gland element can include a top portion having a top surface for contacting a bottom surface of the external actuation subsystem and a bottom flange portion that has a surface that contacts an axially outermost one of the packing elements for applying the axial biasing force thereto. The external actuation subsystem can include a top housing component and a bottom housing component that is separable from and axially movable relative to the top housing component. The top housing component has a main body having a central region that is shaped to accommodate the gland bolt and is disposed between opposed first and second end regions, and the first end region has a first retainer aperture formed therein for seating a first retainer element and the second end region has a second retainer aperture formed therein for seating a second retainer element.

The external actuation subsystem can also include first and second plug elements for coupling to the main body of the top housing component, wherein each of the first and second plug elements includes a groove formed in a peripheral outer surface thereof for seating a plug sealing element. The first plug element is coupled to a bottom surface of the first end region by the first retainer element and the second plug element is coupled to a bottom surface of the second end region by the second retainer element. The bottom housing component can include a first chamber portion, a second chamber portion, and a central portion disposed between the first and second chamber portions. The first chamber portion has a first chamber formed therein for seating a first actuation element and the second chamber portion has a second chamber formed therein for seating a second actuation element.

The first actuation element can have a first central cavity formed therein that is sized and configured for seating the first plug element and a first groove formed in a peripheral outer surface for seating a first sealing element. The second actuation element can have a second central cavity formed therein that is sized and configured for seating the second plug element and a second groove formed in a peripheral outer surface for seating a second sealing element. The first plug element couples the first actuation element to the top housing component when the first plug element is disposed within the central cavity of the first actuation element, and the second plug element couples the second actuation element to the top housing component when the second plug element is disposed within the central cavity of the second actuation element. According to one embodiment, each of the first and second chambers has an inner wall and a floor, and the first sealing element of the first actuation element contacts the inner wall of the first chamber to form a fluid-tight seal between the first chamber and the first actuation element, and the second sealing element of the second actuation element contacts the inner wall of the second chamber to form a fluid-tight seal between the second chamber and the second actuation element. Still further, each of the first and second chamber portions of the bottom housing component can have a fluid port formed therein for receiving the pressurized fluid, such that when the pressurized fluid is introduced into the first and second chambers, the pressurized fluid moves the bottom housing component axially away from the top housing component and towards the gland element to apply the axial actuation force thereto.

The gland bolt has a bolt shaft and a bolt head, and the central region of the top housing component has a fastener-receiving aperture formed therein for receiving the bolt shaft and wherein the bolt head secures the external actuation subsystem to the gland element. The external actuation subsystem is movable between a preloaded position where the external actuation subsystem does not fully apply the axial actuation force to the gland element, and a loaded position where the external actuation subsystem applies the axial actuation force to the gland element. That is, the external actuation subsystem is movable between a preloaded position where the bottom housing component does not fully apply the axial actuation force to the gland element, and a loaded position where the bottom housing component axially move away from the top housing component to apply the axial actuation force to the gland element.

According to a second embodiment, the external actuation subsystem can be configured to move axially along the gland bolt and can include a top housing component and a bottom housing component that are coupled together. The gland bolt can have a bolt head and a bolt shaft, and the bottom housing component can have a chamber formed therein having a sidewall and a floor. The floor portion of the chamber can have a central opening formed therein for seating the bolt shaft and the bolt head is sized and configured seating within the chamber. The external actuation subsystem is movable along the bolt shaft between a preloaded position where the bolt head is disposed adjacent the floor of the bottom housing element and a loaded position where the bolt head is positioned adjacent the top housing component.

The bolt head can have a peripheral outer surface having a groove formed therein for seating a bolt sealing element, and the bottom housing component can be sized and configured such that the bolt sealing element is disposed in fluid sealing engagement with the sidewall of the chamber. The central opening of the floor portion of the chamber can have a groove formed therein for seating a shaft sealing element, and the shaft sealing element can engage with the shaft of the gland bolt to form a fluid tight seal. Further, the bottom housing element has a fluid port formed therein for communicating the pressurized fluid with the chamber for moving the external actuation subsystem between the preloaded and loaded positions. The bottom housing component can also have an anti-rotation element mounted on a bottom surface thereof for coupling to the gland element. The anti-rotation element helps prevents rotation of the external actuation subsystem relative to the gland element during use.

The packing loading assembly can include a follower element movable in an axial direction, and a gland for housing the follower element. The gland comprises a main body having an upper surface, an opposed bottom surface and a side surface, a plurality of fastener-receiving apertures formed in the main body for seating a fastening element, a gland channel formed in the bottom surface of the main body forming a gland pressure chamber, and a fluid supply port formed in the side surface and fluidly communicating with the gland channel. The gland channel comprises a bottom wall surface and opposed first and second side wall surfaces, and a sealing channel formed in each of the opposed first and second side wall surfaces for seating a sealing element. The follower element comprises a first end having a bucket-like structure and an opposed second end having a stem-like structure, wherein the bucket-like structure has a generally U-shaped body having opposed first and second side walls and a bottom wall forming a pressure chamber. The stem-like structure has a foot portion at a terminal end thereof for contacting an axially outermost one of the plurality of packing elements.

The bucket-like structure of the follower element is sized and configured for seating at least partly within the gland channel of the gland. Further, the follower element is movable between a first pre-loaded position where follower element is disposed in an axially outermost position and a second loaded position where the follower element moves axially inwardly, and the foot portion of the follower element contacts the axially outermost one of the plurality of packing elements and applies a loading force thereto.

According to another aspect, the gland channel of the gland has opposed side walls that are radially separated relative to each other and are connected by a bottom wall, and wherein the movable follower element is configured to move between a first pre-loaded position where the bucket-like structure of the follower element is disposed in the gland channel and where a top surface of the bucket-like structure contacts the bottom wall of the gland channel, and a second loaded position where the follower element moves axially inwardly and the top surface of the bucket-like structure is axially separated from the bottom wall surface of the gland channel. The gland pressure chamber of the gland and the pressure chamber of the follower element cooperate to form a pressurized chamber for selectively moving the follower element in an axial direction as a function of the pressure of the fluid within the pressurized chamber.

The system can also include an electronic device for communicating with and controlling the pressure regulator so as to control the pressure of the pressurized fluid exiting the outlet and conveyed to the packing loading assembly.

According to another practice, the present invention is directed to a packing loading assembly for mounting to stationary equipment employing a stacked set of packing elements, comprising a gland and a follower element. The gland includes a main body having an upper surface, an opposed bottom surface and a side surface, a plurality of fastener-receiving apertures formed in the main body for seating a fastening element, a gland channel formed in the bottom surface of the main body forming a gland pressure chamber, and a fluid supply port formed in the side surface and fluidly communicating with the channel. The follower element can include a first end having a bucket-like structure having a generally U-shaped body having opposed first and second side walls and a bottom wall forming a chamber, and an opposed second end having a stem-like structure, having a foot portion at a terminal end thereof for contacting an axially outermost one of the packing elements.

The gland pressure chamber and the chamber of the bucket-like structure are fluidly coupled so as to form a pressurized chamber for axially moving the follower element between a first pre-loaded position and a second loaded position. Further, the gland channel has first and second wall surfaces that are radially spaced apart and a bottom wall surface that is connected to the first and second wall surfaces. When the follower element is disposed in the first pre-loaded position, the bucket-like structure is disposed within the gland channel and a top surface of the bucket-like structure contacts the bottom wall surface of the gland channel. When the follower element is disposed in the second loaded position, the top surface of the bucket-like structure is radially separated from the bottom wall surface of the gland channel.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of the pressure regulating system employing a packing loading assembly according to the teachings of the present invention.

FIG. 2 is a perspective view of a first embodiment of the packing loading assembly for use with the pressure regulating system of FIG. 1 according to the teachings of the present invention.

FIG. 3 is a cross-sectional view of the packing loading assembly showing the movable follower element disposed in a preloaded position according to the teachings of the present invention.

FIG. 4 is a cross-sectional view of the packing loading assembly showing the movable follower element in a loaded position according to the teachings of the present invention.

FIG. 5 is a cross-sectional view of the follower element of the packing loading assembly according to the teachings of the present invention.

FIG. 6 is a schematic representation of a compact integrated structure housing that houses and employs the pressure regulating system of the present invention.

FIG. 7 is a partial perspective view of a pressure regulating system employing a second embodiment of the packing loading assembly according to the teachings of the present invention.

FIG. 8 is a partial cross-sectional view of the packing loading assembly of FIG. 7 according to the teachings of the present invention.

FIG. 9 is a partial perspective view from a rear of the stationary equipment illustrating the packing loading assembly of FIG. 7 according to the teachings of the present invention.

FIG. 10A is a perspective view of one embodiment of a bottom housing component of the external actuation subsystem according to the teachings of the present invention.

FIG. 10B is a cross-sectional view of the bottom housing component of FIG. 10A according to the teachings of the present invention.

FIG. 10C is a cross-sectional view of the external actuation subsystem according to the teachings of the present invention showing the subsystem in a preloaded position.

FIG. 10D is a cross-sectional view of the external actuation subsystem according to the teachings of the present invention showing the subsystem in a loaded position.

FIG. 11 is a perspective view of a second embodiment of the external actuation subsystem of the packing loading assembly of the present invention.

FIG. 12 is a perspective view of a second embodiment of the packing loading assembly according to the teachings of the present invention.

FIG. 13 is a rear perspective view of the packing loading assembly a FIG. 12 according to the teachings of the present invention.

FIG. 14 is a perspective view of the external actuation subsystem of the packing loading assembly of FIG. 12 according to the teachings of the present invention.

FIGS. 15A and 15B are partial cross-sectional views of the external actuation subsystem of FIG. 12 showing the subsystem disposed in a loaded position and in a preloaded position, respectively.

FIG. 16 is a partial cross-sectional view of the packing loading assembly of FIG. 12 according to the teachings of the present invention.

FIG. 17 is a perspective view of the packing loading assembly of FIG. 7 showing multiple (e.g., four) external actuation subsystems coupled to the stationary equipment and that are fluidly connected in series according to the teachings of the present invention.

FIG. 18 is a general schematic diagram showing the use of a sensor assembly and positioned to be coupled to a stationary component and a movable component according to the teachings of the present invention.

FIG. 19 is an example embodiment of the pressure regulating system showing the sensor assembly coupled to an external actuation subsystem according to the teachings of the present invention.

FIG. 20 is a perspective isolation view showing the sensor assembly coupled to the movable and stationary housing components of the external actuation subsystem according to the teachings of the present invention.

FIG. 21 is a cross-sectional view of the sensor assembly coupled to the movable and stationary housing components of the external actuation subsystem according to the teachings of the present invention.

FIG. 22 is an example graph showing a remaining amount of packing material adjustment according to the teachings of the present invention.

### DETAILED DESCRIPTION

The present invention is directed to a measurement and adjustment system used in connection with a packing loading assembly to provide an axial loading force to packing elements housed within stationary equipment in an automated manner. The compressive forces applied to the packing elements can be measured and monitored, and the amount of compression can be selectively regulated, in real time. The compression can be regulated or controlled by use of a pressure regulating system that applies an axial fluid force to a follower element that in turn applies an axial loading force to the packing elements. Those skilled in the art will readily appreciate that the present invention may be implemented in a number of different applications and embodiments and is not specifically limited in its application to the particular embodiment depicted herein.

The term “shaft” as used herein is intended to refer to any suitable device in a mechanical system to which a seal can be mounted and includes shafts, rods, and other known devices.

The terms “axial” and “axially” as used herein refer to a direction generally parallel to the axis of a shaft. The terms “radial” and “radially” as used herein refer to a direction generally perpendicular to the axis of a shaft. The terms “fluid” and “fluids” refer to liquids, gases, and combinations thereof.

The term “axially inner” as used herein refers to that portion of the stationary equipment and/or components of a mechanical seal that are disposed proximate to the stationary equipment (e.g., mechanical system) employing the mechanical seal. As such, this term also refers to the components of the mechanical seal or packing loading assembly that are mounted to or within the stationary equipment or are disposed the deepest within or closest to the equipment (e.g., inboard). Conversely, the term “axially outer” as used herein refers to the portion of stationary equipment and the mechanical seal or packing loading assembly that is disposed distal (e.g., outboard) from the equipment.

The term “radially inner” as used herein refers to the portion of the mechanical seal, packing loading assembly or associated components that are proximate to a shaft. Conversely, the term “radially outer” as used herein refers to the portion of the mechanical seal, packing loading assembly or associated components that are distal from the shaft.

The terms “stationary equipment,” “stuffing box” and/or “static surface” as used herein are intended to include any suitable stationary structure housing a shaft or rod to which a mechanical seal or packing loading assembly having a gland is secured. The stationary structure can include any type of commercial or industrial equipment such as pumps, valves, and the like. Those of ordinary skill in the relevant art will readily recognize that the gland assembly can form part of the mechanical seal, packing loading assembly or part of the stationary equipment.

The terms “process medium” and/or “process fluid” as used herein generally refer to the medium or fluid being transferred through the stationary equipment. In pump applications, for example, the process medium is the fluid being pumped through the pump housing.

The term “gland” or “gland element” as used herein is intended to include any suitable structure that enables, facilitates or assists securing the mechanical seal or the packing loading assembly to the stationary equipment, while concomitantly surrounding or housing, at least partially, one or more seal components. If desired, the gland can also provide fluid access to the mechanical seal.

The term “mechanical seal” as used herein is intended to include various types of sealing structure employed for sealing the process fluid between the movable (e.g., rotating) and stationary components of the stationary equipment and can include for example single seals, split seals, tandem seals, dual seals, concentric seals, gas seals, spiral seals, and other known seal types and configurations.

The term “packing material” as used herein is intended to include resilient and at least partially compressible materials for sealing a variety of fluids in a gland or stationary equipment under a wide array of pressures and temperatures.

The term “packing loading assembly” as used herein is intended to include any selected component or assembly of components, including at least for example a gland, for applying an axial loading pressure to packing elements formed from the packing material so as to provide a seal between the stationary and movable components of at least the stationary equipment.

The term “ambient environment” or “ambient pressure” is intended to include any external environment or pressure other than the internal environment of the gland, packing loading assembly, mechanical seal or stationary equipment.

The present invention is directed to a packing loading assembly having a gland within which a sealed cavity houses a piston loaded follower element that acts on the packing elements. The piston loaded follower element is activated by one or more externally regulated or controlled pressure sources that applies a pressure fluid or medium, such as for example by shop compressed air or a suitable water supply. A pressure regulating system can be used to help adjust, vary, or control the pressure within the gland and thus apply a generally or substantially constant or uniform axial loading force to the packing elements, or can vary the pressure as desired. As the packing elements relax over time due to wear, thermal cycling, vibration or pressure surges, the pressure fluid can be controlled, adjusted, or varied to help maintain a generally or substantially constant or uniform load on the packing elements. A fluid regulating element, such as a valve, can be used in the supply line to the pressure regulator so that the load on the packing elements is maintained even in the case of momentary interruption of the pressurizing fluid supply. The pressurized fluid supplies are commonly available in industrial or commercial plants. The desired load can be set remotely, in a convenient location and away from rotating machinery components, such as a shaft.

The present invention relates to a concept of an improved live pressure load packing loading assembly or system that automatically energizes packing elements mounted in stationary equipment to compensate for packing compression and wear over time. The present invention also allows for packing adjustment at a distance from rotating machinery parts. Once the packing elements are installed in the associated gland of the packing loading assembly and axially loaded with a suitable compressive force, the radial pressure in the packing needs to be equal to or greater than the pressure of the process fluid of the pump at a wet end (e.g., inner end) to effect proper and adequate sealing. The relaxation behaviors of the packing elements can be due to wear, thermal cycling, vibration, or pressure surges.

A structural component, such as a piston loaded follower element, can be configured to supply a hydraulic or pneumatically driven axial biasing force to the packing elements when mounted within the stationary equipment so as to restrict or prevent fluid leakage therefrom and to form a positive seal due to process fluid pressure from the equipment, such as a pump. The gland component can be fixed to the stationary equipment and preferably accommodates the follower element.

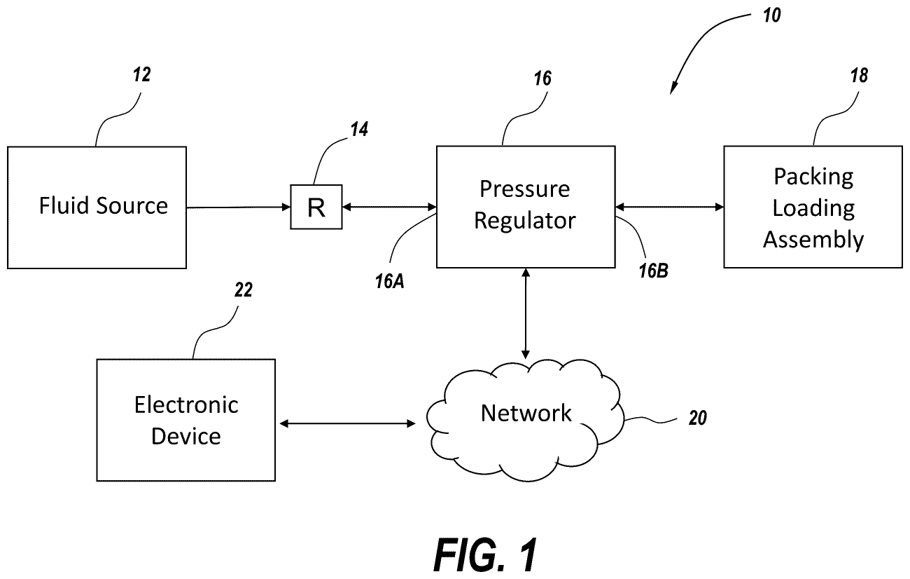

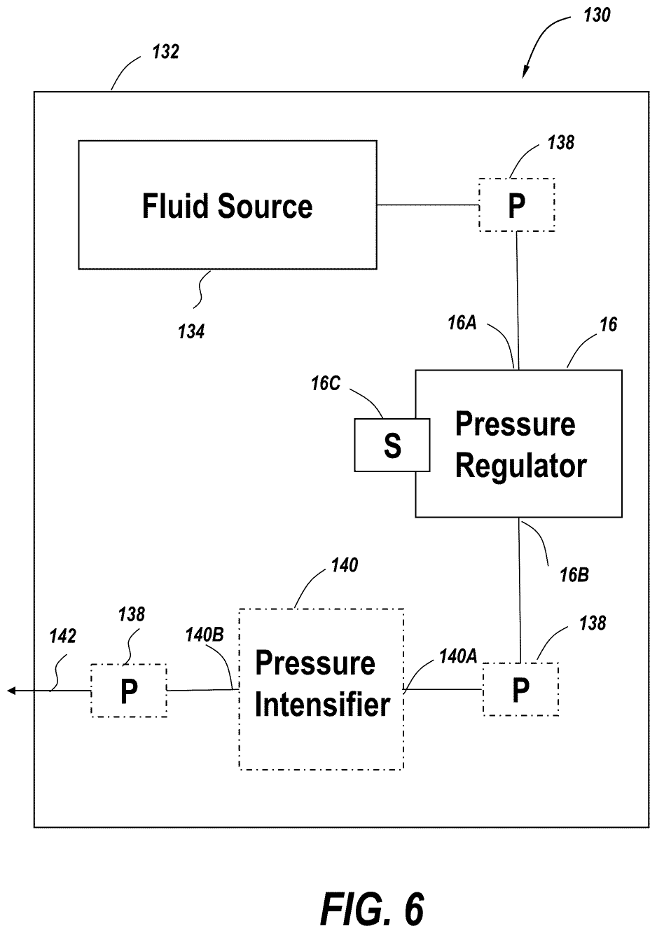

FIG. 1 illustrates the pressure regulating system 10 of the present invention. The pressure regulating system 10 includes a pressurized fluid source 12 for supplying a pressurized fluid to the packing loading assembly 18. The fluid can be a gas, such as air or nitrogen, or a liquid, such as water. The fluid source 12 is coupled through appropriate piping or mechanical connections to a pressure regulator 16 by way of a fluid regulating device 14. The pressure regulator 16 can be any suitable structure or device for regulating, controlling or varying the pressure of a fluid. The pressure regulator 16 has a fluid inlet 16A for receiving the fluid from the fluid source 12 and a fluid outlet 16B for passing the fluid to the packing loading assembly 18. The fluid from the pressurized fluid source 12 enters the fluid inlet 16A at a first higher pressure and typically exits the pressure regulator at the fluid outlet 16B at a second pressure, which can be lower than or substantially equivalent to the inlet pressure. The pressure regulator 16 can include mechanical structure such as a pressure setting or regulating element 16C (FIG. 6), which can include a spring, that is coupled to a sensor, such as a diaphragm or bellows, as is known in the art. The sensor can be configured to sense or detect the pressure of the fluid at the outlet 16B. The sensor can be in turn coupled to a restrictor element, such as a valve seat portion, that can be axially moved so as to control, adjust or vary the amount of fluid exiting the pressure regulator 16, thus controlling the pressure of the fluid at the fluid outlet 16B. The pressure regulator 16 can optionally employ feedback of the regulated pressure as an input to the setting or control mechanism of the regulator and can react to changes in the feedback pressure to control the opening of the restrictor element. The structure and operation of pressure regulators is well known in the art and hence need not be described further herein.

The fluid regulating device 14 can help control or regulate the flow of fluid between the fluid source 12 and the pressure regulator 16. According to one embodiment, the fluid regulating device 14 can be a valve, such as a check valve, that helps prevent the loss of fluid back through the pressure regulator 16 in the event that the fluid source 12 fails to provide an input fluid and corresponding pressure to the inlet of the pressure regulator 16. That is, the valve can be used in the supply line to the pressure regulator 16 so that the load on the packing elements is maintained even in the case of momentary or sustained interruption of the pressurizing fluid supply. The structure and operation of check valves is well known in the art and need not be described further herein. The pressure regulating system 10 can also employ for example one or more pressure sensors or detectors, such as pressure gauges, to measure the pressure of the fluid in the system at selected locations. The pressure sensors can be positioned at any selected location, such as on either side of the pressure regulator 16 or between the pressure regulator and the packing loading assembly 18.

The pressure regulator 16 and/or the packing loading assembly 18 can optionally communicate with an electronic device 22 either directly or through a network 20. The pressure regulator 16 and the packing loading assembly 18 can communicate directly with the electronic device 22 via any suitable wireless connection, such as Wi-Fi and Bluetooth connections. Alternatively, the devices can communicate with the electronic device 22 over a standard network 20. As is known, the network 20 can include one or more electronic devices such as servers, computers and the like. The servers can include appropriate processors, storage and memory as is known in the art. Further, suitable operational software can be stored in the storage for operating and controlling the servers and if desired one or more elements of the pressure regulating system 10. The electronic device 22 can be any suitable device, such as a server, computer, tablet, smartphone and the like. Similar to the servers of the network 20, the electronic device can also include known hardware such as one or more processors, memory and storage, as well as other structure, such as for example input devices (e.g., mouse and/or keyboard) and a display. Suitable system software can be stored either or both in the network 20 and the electronic device 22 for controlling and operating one or more elements of the pressure regulating system 10 and for displaying selected system related information, such as pressure, temperature, and information associated with or related to the packing loading assembly 18.

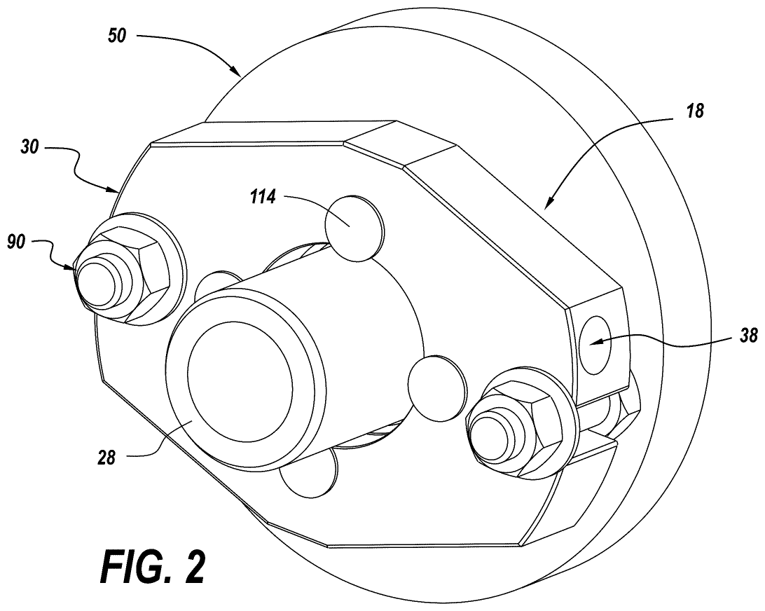

FIGS. 2-5 illustrate the features and elements of a first embodiment of the packing loading assembly 18 of the present invention. The packing loading assembly 18 can include a gland element 30 that is coupled to stationary equipment 50 by way of a series of fastening elements 90. The stationary equipment 50, which can include for example the housing of a pump, has a movable shaft 28 that extends outwardly therefrom and includes a process fluid that needs to be sealed within the pump housing. The shaft 12 can either rotate or can move linearly (e.g., reciprocate). The stationary equipment 50 can include a main body 52 that has a plurality of fastener receiving apertures 54 formed therein. The main body 52 also has a radially inner channel 56 formed therein having a bottom surface or flange portion 58 and an axially extending wall surface 60. The channel 56 seats the packing elements 110, such as a series of ring like packing elements that form a seal between the shaft 28 and the main body 52 of the stationary equipment 50 so as to seal the process fluid therein. The channel 56 can also seat if desired or necessary one or more bushings or bearing elements to help prevent one or more of the packing elements 110 from accidentally extruding from the channel 56. Hence, in operation, the packing elements 110 help form a seal between the elements and the shaft 28 as well as between the elements and the surfaces of the channel 56. The main body of the stationary equipment 50 has a top surface 52A and an opposed bottom surface 52B. The bottom surface 52B has a channel 62 formed therein for seating a sealing element. Those of ordinary skill in the art will readily recognize that the housing of the stationary equipment can have any selected configuration, and that the currently illustrated configuration is for purposes of illustration.

The packing loading assembly 18 can also include a gland element 30 and a follower element 70 that can be pre-assembled into a cartridge or can be separate mountable elements or components. The gland element 30 has a main body 32 that has opposed top and bottom surfaces 32A and 32B, respectively, as well as a side or peripheral surface 32C. The top surface 32A has a plurality of fastener-receiving apertures 34 formed therein for receiving a fastener assembly, including the fastener element 90. The fastener element 90 can be a bolt-like element that mates with a jam nut 92 on an axially inner end and with a washer 94 and a nut 96 at an axially outer end. Likewise, the top surface 32A of the main body 32 of the gland 30 can also optionally include a plurality of centering apertures 36 for seating a centering element, such as the centering button 114. The centering button 114 helps center the gland 30 relative to the shaft 28 during installation, as is known in the art. The bottom surface 32B of the gland 30 also includes an annular channel 40 forming an annular chamber.

The side surface 32C of the gland 30 can include one or more fluid supply ports 38 for supplying a pressurized fluid to the packing loading assembly 18 for applying a pressure to the packing elements 110 via the follower element 70. The fluid supply port 38 can include a first wide port section 38A for coupling to any selected fluid connection element, such as a pipe. The fluid supply port 38 also includes a second radial extending section 38B and a third axial extending section 38C that communicates with the channel 40. The side surface of the channel 40 has a pair of opposed channels 42, 44 formed therein for seating a sealing element 46, 48, respectively. The sealing elements 46, 48 form a fluid-tight seal with the follower element 70. The fluid supply port 38 can be formed in other surfaces of the gland 30 if desired. Those of ordinary skill in the art will readily recognize that the gland can have any selected shape or configuration, and that the currently illustrated configuration is for purposes of illustration.

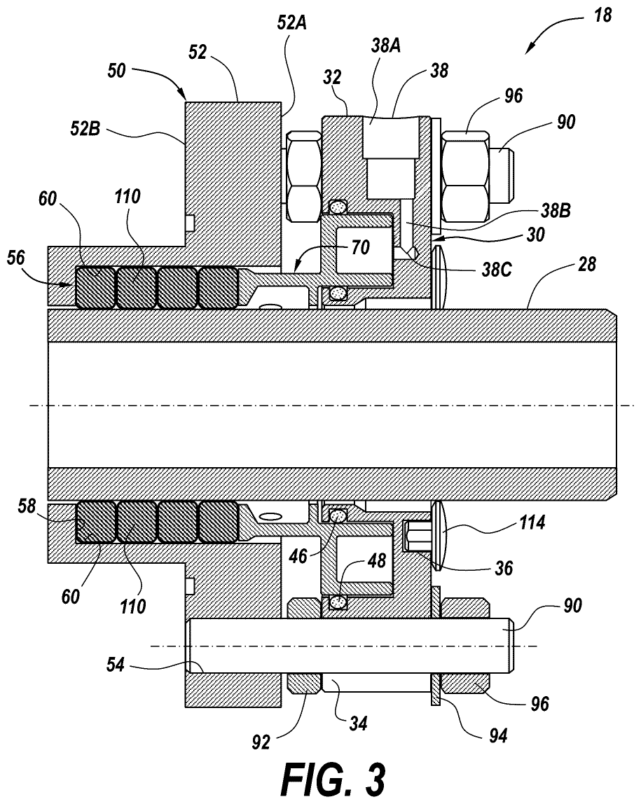

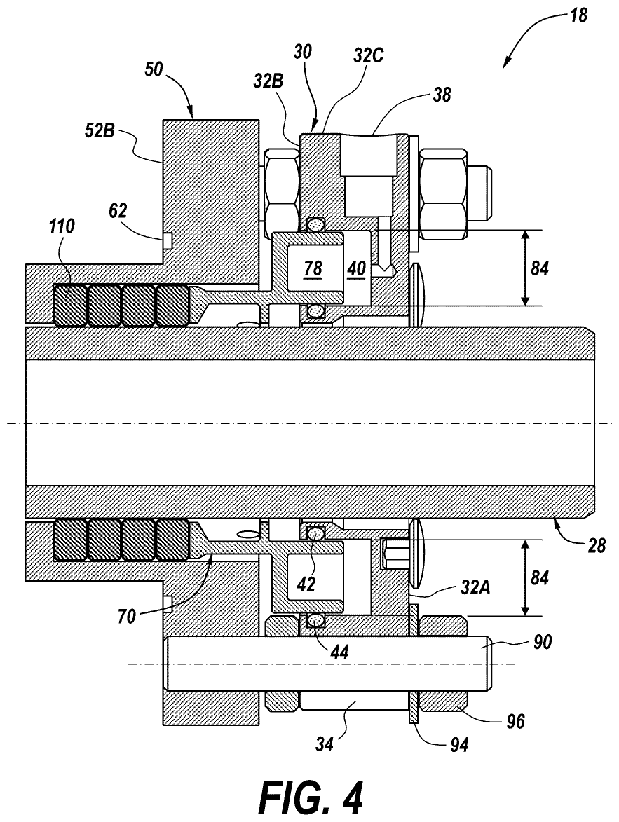

The follower element 70 is axially movable and is sized and configured for applying an axial load or force to the packing elements 110 when properly pressurized by fluid applied thereto through the fluid supply port 38. The follower element 70 is movable between a pre-loaded position (FIG. 3) and a loaded position (FIG. 4). In the pre-loaded position, the follower element 70 contacts or is slightly separated from the packing elements 110 but does not properly or sufficiently load or apply an axial force thereto. When the pressurized fluid is supplied to the fluid supply port 38, the follower element 70 moves from the pre-loaded position to the loaded position and applies an axial force or load to the packing elements 110 so as to seal the process fluid within the stationary equipment 50.

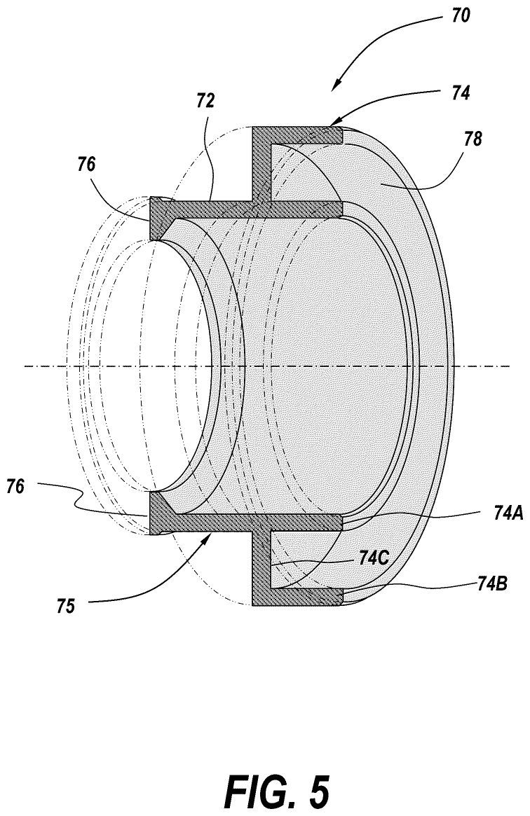

The follower element 70, as shown in FIGS. 3-5, and especially in FIG. 5, includes a main body 72 having an axial first end having a bucket like structure 74 and an opposed second end having a stem-like structure 75 having a foot portion 76. The bucket like structure 74 has a main body having a U-shaped bucket structure that forms a chamber 78 that in connection and cooperation with the channel 40 forms a pressurized chamber for axially moving the follower element 70. The bucket structure 74 has a pair of opposed walls 74A and 74B that are radially spaced apart and are connected by a bottom wall 74C. The walls 74A, 74B, 74C have inner and outer surfaces. The stem-like structure has a main body having a substantially elongated, narrow stem like shape that terminates at a terminal end in a foot portion 76. The foot portion 76 has a larger, radial, planar surface area than the stem-like structure 74 and is configured to contact the axially outermost packing element 110 and apply an axial inward force to supply an axial load to the packing elements 110. Those of ordinary skill in the art will readily recognize that the follower element can have any selected configuration, and that the currently illustrated configuration is for purposes of illustration.

The pressure regulating system 10 can optionally include a pressure regulating subassembly 130 that includes selected elements of the pressure regulating system, including for example at least the fluid source and the pressure regulator. FIG. 6 shows one embodiment of a self-contained pressure regulating subsystem 130 suitable for use with the packing loading assembly 18 according to the teachings of the present invention. As shown, the pressure regulating subsystem 130 can include a housing 132 that can have any selected shape or size, and preferably is formed as a box. The box can have any suitable cover element, if desired, such as a door (not shown). The housing 132 can have the pressure regulating subsystem 130 mounted therein. The illustrated pressure regulating subsystem 130 can include a self-contained pressurized fluid source 134 that can be connected by suitable fluid conduits, such as piping, to the pressure regulator 16. The fluid source 134 can be the same as or similar to the fluid source 12. The pressure regulator 16 can include the pressure setting element 16C for setting the pressure level of the fluid at the outlet 16B of the pressure regulator. A fluid regulating element, such as a check valve (not shown), can also be included in the subsystem if desired. One or more optional pressure sensors, such as pressure gauges 138, can be used to detect or sense the pressure at selected locations of the pressure regulating subsystem 130, as shown.

The illustrated pressure regulating subsystem 130 can also include an optional pressure intensifier 140. The pressure intensifier 140 can be employed to increase the pressure of the fluid exiting the pressure regulator 16 to a higher-pressure level suitable for use with the packing loading assembly 18. Specifically, the pressure intensifier 140 has a fluid inlet 140A and a fluid outlet 140B. The fluid enters the fluid inlet 140A of the pressure intensifier at a first pressure level and exits the fluid outlet 140B at a second higher pressure level. As is known in the art, the pressure intensifier 140 can be constructed so as to provide a predetermined pressure increase. The pressure intensifier can thus be selected to provide a pressurized fluid at the fluid outlet 140B that is sufficient to provide an axial load on the packing elements 110. The pressurized fluid 142 exiting the pressure regulating subsystem 130 is then conveyed to the packing loading assembly 18 for energizing the packing elements 110.

In operation, the pressure regulating system 10 of the present invention can function and operate as follows. The packing loading assembly 18 of the present invention can be mounted to a stuffing box or stationary equipment 50 that includes a rotating shaft 28. In the channel 56 of the equipment 50, a stacked series of packing elements 110 are mounted therein. The packing loading assembly 18 includes the gland 30 and the follower element 70, and the gland 30 is coupled to the stationary equipment 50. Specifically, the foot portion 76 of the follower element is placed adjacent to and in contact with the axially outermost packing element 110. The bucket-like structure 74 of the follower element 70 seats within the channel 40 of the gland 30. The gland 30 is secured to the stationary equipment 50 by the fastener assemblies that includes the fastening element 90, the jam nut 92, the washer 94, and the nut 96. The centering device 114 can be employed to center the packing loading assembly 18 about the shaft 28. The packing loading assembly can also employ, if desired, a clip element (not shown) that can have a selected portion that seats between the follower element and the top surface of the stationary equipment for holding the follower element in the pre-loaded position during assembly and prior to operation.

The illustrated gland 30 includes a main body 32 having the channel 40 formed in the underside or bottom surface 32B to seat the upper bucket like portion of the follower element 70. The gland 30 has formed therein a fluid supply port 38 in a side surface 32C thereof that communicates with the channel 40. Additional sealing elements, such as O-rings, can be employed to help seal the pressurized fluid within the packing loading assembly. The follower element 70 has an upper portion that includes a bucket-like structure 74 that forms a chamber 78 that is positioned within the channel 40 formed in the gland 30, and an opposed lower portion that includes the foot portion 76 that is configured to contact and hence provide an axial load on the stacked packing elements 110. The combination of the channel 40 and corresponding chamber formed thereby and the chamber 78 of the bucket-like structure 74 form a pressurized fluid chamber.

The follower element 70 can be disposed in a first or initial pre-loaded position where the upper topmost surface of the bucket-like structure 74 of the follower element 70 is immediately adjacent to or contacts a floor or bottom wall surface 74C of the gland channel 40. The outer or exterior surfaces of the walls 74A, 74B of the bucket-like structure 74 can also contact if desired the side walls or surfaces of the gland channel 40. The channel 40 and the chamber 78 of the bucket-like structure 74 form in combination a fluid chamber that can be pressurized by the fluid source 12 to move the follower element 70 in an axial inward direction into the loaded or working position where the foot portion 76 of the follower element applies an axial load to the stacked set of packing elements 110. When axially loaded, the packing elements 110 help form a fluid seal to reduce or prevent leakage of the process fluid from the stationary equipment 50.

The pressure regulating system 10 provides a fluid, such as water, oil, air, or nitrogen, from the fluid source 12 that passes through the fluid regulator 14 and to the pressure regulator 16. The pressure regulator 16 can be optionally remotely controlled either directly or through the network 20 by the electronic device 22. The electronic device 22 helps set or define the pressure of the fluid exiting the pressure regulator 16 by establishing or setting the pressure level. Preferably, the pressure of the fluid exiting the pressure regulator 16 can be manually set via the setting element 16C. The fluid exiting the pressure regulator 16 can be selected according to system needs. The pressurized fluid is introduced by suitable conduits or piping to the fluid supply port 38 formed in the gland 30. The fluid supply port 38 communicates with the channel 40 of the gland and cooperates with the chamber 78 of the follower element to form the pressurized fluid chamber.

The pressurized fluid acts upon the bucket-like structure 74 of the follower element 70, and specifically the fluid acts upon a piston loaded area 84 defined between the outer surface of the radially outermost wall 74A of the bucket-like structure 74 and the outer surface of the radially innermost wall 74B of the bucket-like structure 74. The piston area 84 as formed by the bucket-like portion of the follower element is sized and dimensioned so that the axial load applied to the packing elements via the follower element is sufficient to effectuate a seal of the process fluid within the stationary equipment given the pressure of the fluid supplied by the fluid source 12. Those of ordinary skill in the art will readily be able to determine the appropriate size of the piston areas based on the overall dimensions of the packing loading assembly including the sizes of the follower element and the gland, and the pressure of the source fluid and the process fluid. The force of the pressurized fluid acting upon the piston area 84 of the follower element 70 axially moves the follower element 70, when sufficiently pressurized, from the pre-loaded position into the loaded position and therebetween. That is, when sufficiently pressurized, the piston loaded follower element 70 moves axially into the second loaded working position to apply a selected loading force to the packing elements 110. In this second position, the upper bucket-like 74 portion of the follower element 70 is spaced from the floor of the gland channel 40. The fluid supply port 38 can be coupled to any suitable fluid supply.

The electronic device 22 can optionally control the amount of force applied to the packing elements 110 by varying, regulating, or controlling the pressure of the fluid with the pressure regulator 16. That is, the pressure regulator 16 can sense the pressure within the packing loading assembly 18 by sensing the fluid pressure at the fluid outlet 16B thereof. The electronic device 22 can control the outlet pressure of the pressure regulator 16 by adjusting or manipulating the setting element of the pressure regulator. The pressure applied to the packing elements 110 through the piston loaded follower element 70 can thus be varied or adjusted based on the sealing capabilities of the packing material and in real time based on the load characteristics of the packing elements 110. Specifically, the pressure of the process fluid may change during operation of the packing loading assembly, and the sealing capabilities or characteristics of the packing material may change over time. As such, the pressure within the packing loading assembly changes and hence the loading force applied to the packing elements and necessary to maintain the fluid seal changes over time as well. The electronic device 22 via the pressure regulator can vary, adjust, or change the pressure of the pressurized fluid introduced to the packing loading assembly 18 to apply and maintain a selected substantially constant or uniform pressure on the packing elements in real time. The force can thus be controlled continuously and dynamically to maintain the substantially uniform pressure on the packing elements 110. Alternatively, the pressure of the fluid supplied to the packing loading assembly 18 can be set by the pressure regulator 16 by manually adjusting the setting element 16C of the regulator. As used herein, the terms “substantially unform” or “substantially constant” or “constant” or “uniform” are intended to include the ability to adjust, vary or control the pressure of the fluid supplied to the packing loading assembly such that the pressure varies by less than 2.0 psi, and preferably less than 1.0 psi.

According to one practice, the force applied to the packing elements 110 through the piston loaded follower element 70 can be remotely controlled through any suitable network 20. Further, the fluid supply pressure supplied to the packing loading assembly 18 can be controlled such that the pressure is automatically adjusted based on the wear characteristics of the packing material of the packing elements 110. There is no need to manually assess the sealing capabilities of the packing material and to manually adjust the force applied to the packing elements 110, such as by tightening a gland bolt, as is done in the prior art. Rather, the system 10 of the present invention allows the loading pressure applied to the packing elements 110 to be remotely controlled and to be controlled in an automated manner, thus reducing or eliminating the need for manual tightening of the gland bolts.

Further, the gland 30 and the piston loaded follower element 70 can optionally form a cartridge that can create a hydraulic or pneumatic cylinder actuation force. Thus, the present invention improves upon conventional products that live-load pump packing by providing a relatively or substantially constant or uniform force on the packing elements 110 rather than a fluctuating force or a force that decreases over time based on the wear characteristics of the packing material as well as a decrease or change in the force profile applied by loading springs in conventional systems. Thus, according to another practice, the present invention allows an operator to manually adjust the force applied to the packing material, if needed or desired, via the setting element 16C of the pressure regulator 16.

The loading mechanism of the present invention can operate with a wide variety of packing materials, including injectable packing materials. When using injectable packing material, the stuffing box can be refilled and hence no packing gland adjustments are required to return to the original positioning as the piston is pushed back within the gland and the optimal pressure load is maintained by the pressure regulator 16. For example, the mechanical packing can include braided compression packing, which can be fabricated from carbon, graphite, and/or synthetic fibers, to provide a versatile sealing solution suitable for a wide range of industrial applications. Another widely used type of packing is polytetrafluoroethylene (PTFE) packing, including both filament and encapsulated constructions, which provides resistance to chemical attack and corrosion and is therefore suitable for chemically aggressive process fluids. Graphite-based packing, including flexible graphite and carbon/graphite composites, can also be employed and is characterized by favorable thermal conductivity, resistance to thermal degradation, and suitability for elevated temperatures and high shaft surface velocities. Acrylic-based packing materials provide a comparatively low-cost alternative and can be utilized in applications involving mild acids, alkalis, brines, and oils. Aramid-fiber packing, such as that formed from Kevlar® or similar high-strength fibers, is further used where high mechanical durability is required, including in reciprocating pump applications and in environments involving high pressures and moderate operating temperatures.

The gland 30 and/or the piston loaded follower element 70 can be adjusted for a wide range of axial travel and pressures. The present invention thus eliminates or reduces the need for periodic manual adjustments required with traditional bolted glands.

The present invention also provides for precise packing load control, which is more accurate than typical bolted gland assemblies. The system of the present invention also provides for remote adjustment for safety (e.g., no need for manually adjusting gland bolts near a rotating shaft). Specifically, many plant regulations do not allow mechanics near rotating elements after the pump has been started. However, the system 10 of the present invention can be configured so that the packing gland can be easily and remotely adjusted (i.e., from a safe distance away). Further, since the system 10 can employ existing hydraulic (i.e., water or oil) or pneumatic (i.e., air or nitrogen) systems that are present within many industrial installations, no significant retrofitting of the stationary equipment is necessary to employ the gland and follower element assembly.

In the system of the present invention, the load applied to the packing elements 110 can be relatively constant or uniform, as compared with prior art systems where the deflection of the loading structure changes over time, thus applying a non-constant or changing load to the packing elements 110.

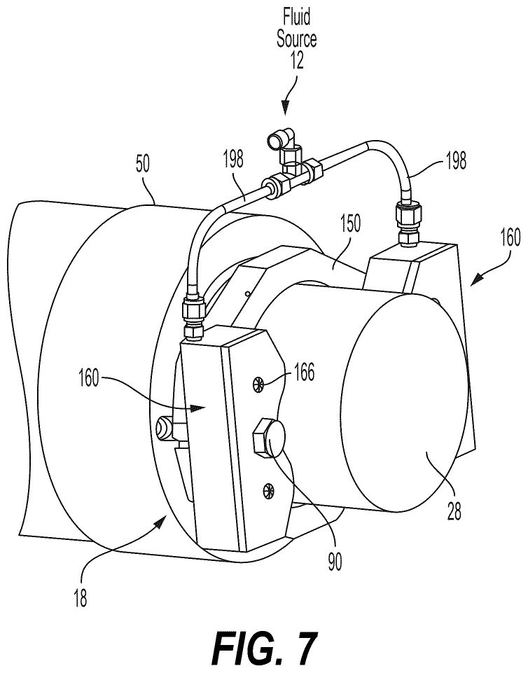

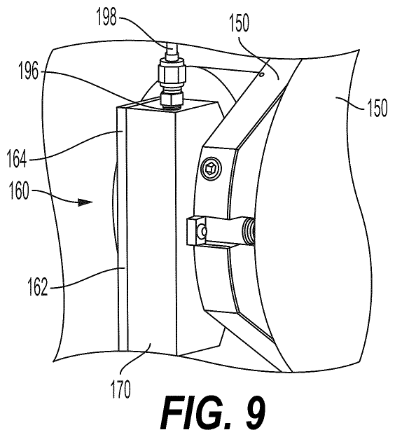

FIGS. 7-11 illustrate a second embodiment of the packing loading assembly 18 for use with the pressure regulating system 10 of the present invention. Like reference numbers indicate like parts throughout the various views. The illustrated pressure regulating system 10 provides an external actuation subsystem for automatically applying a load to the packing elements 110. Specifically, the illustrated packing loading assembly 18 in the second embodiment of the invention provides a biasing force to the packing elements 110 via an external actuation subsystem as compared with providing fluid ports formed directly in the gland element as employed in the first embodiment.

The present invention is directed to a packing loading assembly 18 having a gland and an external actuation subsystem that includes an actuation element (e.g., a follower element) that acts on the gland element and hence the packing elements 110 so as to apply an axial biasing force thereto. The actuation element of the external actuation subsystem is activated by one or more externally regulated or controlled pressure sources that applies thereto a pressure fluid or charging medium, such as for example compressed air or a suitable water supply. A pressure regulating system can be used to help adjust, vary, or control the pressure within the gland and thus apply a generally or substantially constant or uniform axial loading force to the packing elements 110, or can vary the pressure applied to the packing elements 110 as desired. One example of a suitable pressure regulating system is the pressure regulating system 10 of FIG. 1. As the packing elements 110 relax over time due to wear, thermal cycling, vibration or pressure surges, the pressure fluid applied to the packing elements 110 can be controlled, adjusted, or varied to help maintain a generally or substantially constant or uniform load thereon. A fluid regulating element, such as a valve, can be used in the supply line to the pressure regulator so that the load on the packing elements is maintained even in the case of momentary interruption of the pressurizing fluid supply. The pressurized fluid supplies are commonly available in industrial or commercial plants. The desired load can be set remotely, in a convenient location and away from rotating machinery components, such as a shaft.

The second embodiment of the present invention also relates to the concept of providing an improved live pressure load packing loading assembly that automatically energizes or charges the packing elements 110 mounted in the stationary equipment 50 to compensate for packing compression and wear over time. The present invention also allows for packing force adjustment by field personnel at a distance from rotating machinery parts. Once the packing elements 110 are installed in the stuffing box of the stationary equipment 50 and axially loaded with a suitable compressive force, the radial pressure in the packing elements needs to be equal to or greater than the pressure of the process fluid of the stationary equipment at an inner end (e.g., wet end) to effect proper and adequate sealing. The relaxation behaviors of the packing elements 110 over time can be due to wear, thermal cycling, vibration, or pressure surges.

A structural component, such as an actuation element, can be configured to supply a hydraulic or pneumatically driven axial biasing force to the packing elements 110 when mounted within the stationary equipment 50 so as to restrict or prevent fluid leakage therefrom and to form a positive seal due to process fluid pressure from the equipment.

As shown in FIGS. 7-9, the illustrated packing loading assembly 18 includes a gland element 150 that is coupled to the stationary equipment 50 by way of a series of fastening elements 90, such as gland bolts. The gland element 150 has a main body that has a fastener receiving aperture 152 formed therein for receiving a portion of the shaft of the gland bolt 90. The gland element 150 also includes a top portion 154 having a top surface for contacting a surface of the external actuation subsystem 160 and a bottom flange portion 156 that has a surface that contacts the axially outermost packing element of the series of packing elements 110 for applying an axial biasing force thereto. The stationary equipment 50, which can include for example the housing of a pump, has a movable shaft 28 that extends outwardly therefrom and includes a process fluid that needs to be sealed within the pump housing. The shaft 28 can either rotate or can move linearly (e.g., reciprocate) relative to the stationary equipment. The stationary equipment 50 can include a main body 52 that has a plurality of fastener receiving apertures 54 formed therein. The fastener receiving aperture 54 can include an optional insert element 148 that helps retain a terminal end portion or region of the gland bolt within the aperture 54. The main body 52 of the stationary equipment also has a radially inner channel 56 formed therein having a bottom surface or flange portion 58 and an axially extending wall surface 60. The channel 56 seats the packing elements 110, such as a series of ring like packing elements, that form a seal between the shaft 28 and the main body 52 of the stationary equipment 50 so as to seal the process fluid therein. The packing loading assembly 18 can also include an optional sleeve element 146 that is coupled to the shaft and is rotatable therewith. The sleeve element 146 can be disposed between the packing elements 110 and the shaft 28. The sleeve element 146 can function as a protective barrier and a sealing interface between the shaft 28 and the packing elements 110, thus ensuring effective sealing while preventing the leakage of fluids from the stationary equipment 50. The sleeve element 146 can also serve to protect the shaft 28 and the packing elements 110 from wear and damage. For example, as the shaft 28 rotates, the shaft can cause friction and wear against the packing elements 110, leading to premature wear and reduced sealing effectiveness. The sleeve element 146 helps distribute this wear and protects both the shaft and the packing elements, extending the usable life of the sealing components. The sleeve element 146 also helps maintain the proper alignment of the packing elements 110 relative to the shaft 28. The sleeve element 146 ensures that the packing elements 110 remain securely in place and do not inadvertently shift or move during operation, which can lead to leaks or inefficient sealing. The channel 56 can also seat if desired or necessary one or more optional bushings or bearing elements to help prevent one or more of the packing elements 110 from accidentally extruding from the channel 56. Hence, in operation, the packing elements 110 help form a seal between the stationary equipment and the sleeve element 146 or the shaft 28. The main body 52 of the stationary equipment 50 has a top surface 52A and an opposed bottom surface. Those of ordinary skill in the art will readily recognize that the housing of the stationary equipment can have any selected configuration, and that the currently illustrated configuration is for purposes of illustration.

The channel 56 formed in the stationary equipment 50 can also seat an optional support element 190, such as a lantern ring. The lantern ring 190 can be disposed between the bottom surface 58 of the channel 56 and the packing elements 110. The lantern ring 190 helps axially position the packing elements 110 in the groove 56 and helps maintain the correct axial alignment of the packing elements 110, ensuring that they are in the proper contact and alignment to effectively seal the equipment. The lantern ring 190 can also offer radial support to the packing elements 110. The radial support helps prevent excessive deflection or misalignment of the sealing surfaces or faces of the packing elements, which can occur due to operational forces and vibrations in the equipment. Proper radial support contributes to the longevity and performance of the mechanical seal. The lantern ring 190 can also stabilize the packing elements 110, especially in applications where there may be some degree of misalignment or shaft deflection. The lantern ring 190 helps maintain the integrity of the fluid seal and prevents excessive wear or damage to the sealing faces of the packing elements.

The packing elements 110 can be compressed within an annular space formed by the channel 56 of the stationary equipment 50 (e.g., the stuffing box) that is disposed around the shaft 28. The gland bolts 90 can be used to compress the packing elements 110 to form a fluid-tight seal to the shaft 28. As the packing elements 110 wear, the axial biasing load decreases over time and fluid leakage about the shaft increases, such that gland bolt adjustments are required on a more regular basis. The biasing elements (e.g., springs) of various conventional configurations and designs have been used to maintain a biasing load on the packing elements 110 during adjustment periods. However, the load decreases as the springs elongate, and the axial travel is limited. Thus, conventional biasing approaches have significant drawbacks and limitations.

One basic principle of the second embodiment of the packing loading assembly 18 of the present invention is to employ an external actuation subsystem 160 that functions as a fluid power actuator that is mounted externally to the gland element 150 (e.g., is not formed within the gland element) and to the gland bolts 90 and functions to bias the gland element 150 in an axial direction against the packing elements 110. The actuation portion of the external actuation subsystem 160 is activated by an externally regulated pressurized fluid supplied by the pressure source 12 and can employ any suitable fluid, such as for example compressed air, nitrogen, or water. The pressure regulator 16 can be used to adjust the axial force applied to the gland, and thus can essentially adjust the uniform load transmitted to the packing elements 110.

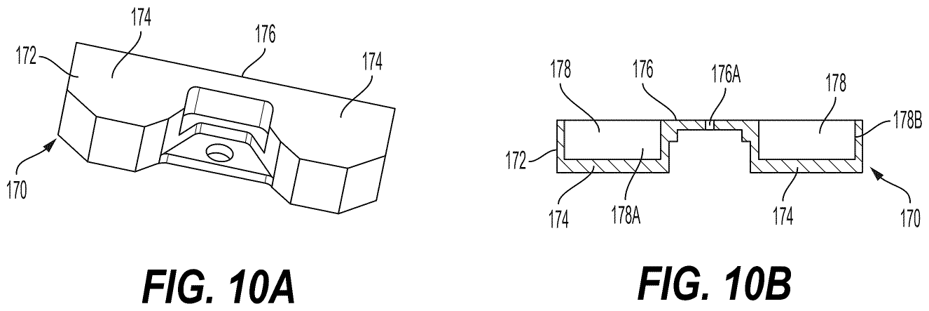

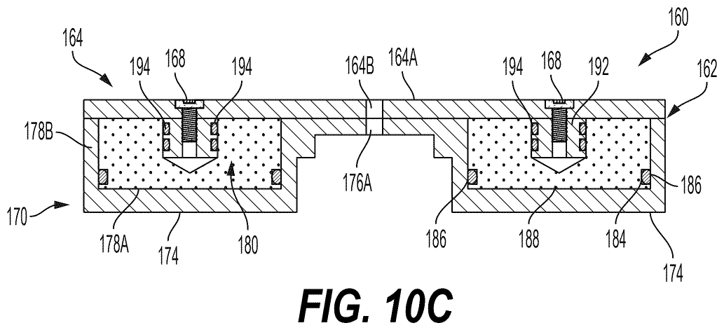

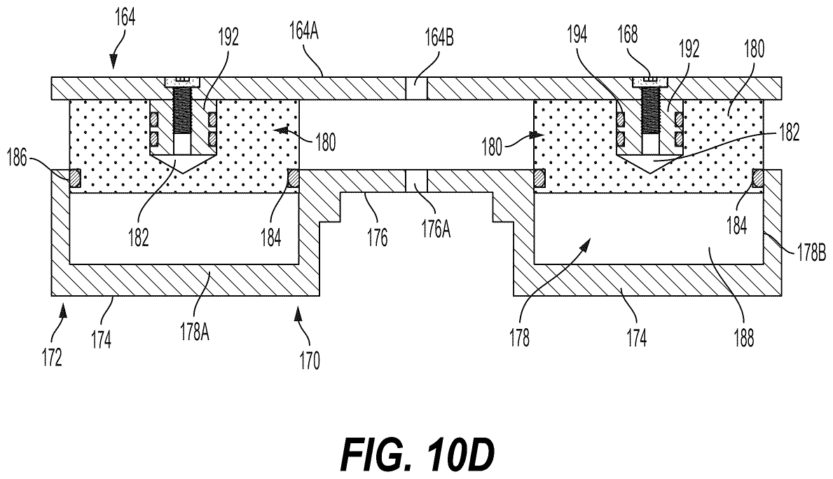

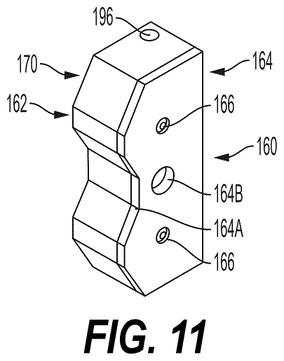

The external actuation subsystem 160 of the present invention is shown for example in FIGS. 7-11, with particular reference to FIGS. 10A-10D and 11. The illustrated external actuation subsystem 160 is secured to the gland element 150 by way of the gland bolts 90. According to one embodiment, the external actuation subsystem 160 includes a housing 162 that is sized and configured to hold, mount or secure multiple actuators. The housing 162 includes a first or top housing component 164 that is coupled to and overlies a second or bottom housing component 170. The top housing component 164 can have a peripheral shape that is complementary to the peripheral shape of the bottom housing component 170. The top housing component 164 can have a central region 164A that is shaped to accommodate the gland bolt 90 or shaped to accommodate the shaft 28 and is disposed between opposed end regions. Alternatively, or additionally, the central region 164A can have an aperture 164B formed therein for seating a portion of the gland bolt 90. The top housing component 164 can also have formed therein a pair of retainer apertures 166 that are sized and configured for seating a retainer element 168, such as a screw. The retainer element 168 can be mechanically coupled to a plug element 192 for coupling or securing the plug element 192 to an underside or bottom surface of the top housing component 164. The plug element 192 can have one or more grooves formed therein for seating a sealing element 194, such as an O-ring. The plug element 192 can be used to secure the actuation element 180 to the top housing component 164.

The illustrated bottom housing component 170 has a main housing 172 that includes two or more chamber portions 174 that are connected by an intermediate housing portion 176. The intermediate housing potion 176 can have a fastener aperture 176A formed therein. The chamber portions 174 can each have a chamber 178 form therein. The chamber 178 can include a bottom surface 178A and a wall surface 178B. The chamber 178 can be sized and configured to seat the actuation element 180. The actuation element 180 includes a central cavity 182 that is sized and configured to seat the plug element 192. The sealing element 194 of the plug element 192 is adapted to form a seal between the plug element 192 and an inner wall or surface of the cavity 182 of the actuation element 180. The actuation element 180 can also include a groove 184 formed along an outer peripheral surface for seating a sealing element 186, such as an O-ring. When disposed within the chamber 178, the actuation element 180 is spaced from the bottom surface 178A of the chamber 178 to form a fluid gap or space 188. The sealing element 186 also contacts the wall 178B of the chamber to form a seal between the actuation element 180 and the chamber wall 178B. The main housing 172 can also include a fluid port 196 formed in the side wall 178B of the housing and chamber that fluidly communicates with the fluid gap 188. The fluid port 196 can be coupled to an external fluid conduit 198, such as a fluid supply pipe, for conveying a charging or actuation fluid to the fluid gap 188. The charging fluid can be supplied by the fluid source 12.

The external actuation subsystem 160 can be energized by the pressurized fluid to move between a pre-loaded position, where the bottom housing component 170 does not apply an axial load to the packing elements (FIG. 10C), to a loaded position (FIG. 10D) where the bottom housing component 170 applies the axial load to the packing elements 110. The axial load energizes the packing elements 110 to form a fluid tight seal between the shaft 28 and/or sleeve 146 and the packing elements 110 as well as between the packing elements 110 and selected surfaces of the stationary equipment. More specifically, the charging fluid serves to act upon the bottom surface of the actuation element 180 and on the chamber floor 178A so as to separate the bottom housing component 170 from the top housing component 164 and the actuation element 180 into the loaded position, as shown in FIG. 10D. Specifically, the top housing component 164 can remain relatively stationary and the bottom housing component 170 can be moved axially so as to apply a biasing force to the gland element 150 and to the packing elements 110. The sealing element 186 serves to provide a fluid seal between the chamber wall 178B and the actuation element 180 to retain the charging fluid introduced into the fluid gap 188 through the fluid port 196 within the fluid gap 188. The bottom housing component 170 when separated from the top housing component 164 contacts the top portion 154 of the gland element 150 and applies an axial biasing force thereto. The axial biasing force forces the bottom flange portion 156 of the gland element 150 into contact with the packing elements 110, thus applying an axial biasing force the assembly of packing elements. The bottom housing component 170 can be separated from the top housing component 164 by any selected amount or distance as defined by the dimensions of the chamber 178.

In operation, the external actuation subsystem 160 can be mounted about the gland bolt 90 by seating the gland bolt 90 in the apertures 164B, 176A formed in the housing components 164, 170, respectively. When this occurs, the chambers 178 and associated actuation elements 180 are mounted on opposite sides of the gland bolt 90. The bottom housing component 170 can be coupled to the fluid supply system, indicated by the fluid conduits 198. The fluid from the fluid source 12 can be eventually supplied to the chambers 178 via the fluid conduits 198 to the bottom housing component 170, and specifically can be supplied to the fluid gap 188 formed between the actuation element 180 and the floor 178A of the chamber 178. The pressurized fluid can axially move the bottom housing component 170 away from the relatively stationary actuation elements 180 and from the top housing component 164. The bottom housing component 170 contacts the top portion 154 of the flange element 150 and applies an axial force thereto. The bottom flange portion 156 of the gland element 150 then applies an axial biasing force to the packing elements 110 so as to help form and retain a fluid seal between the packing elements 110 and the sleeve element 146.

The external actuation subsystem 160 can apply pressure to the gland element 150 to load the compression packing elements 110. The present invention improves upon existing products that live-load pump packing by providing a relatively constant or uniform force or pressure instead of a spring force that applies inconsistent and decreasing levels of force over time. The pressure regulating system 10 can employ commonly available fluids, such as compressed air or water, that can be supplied via a pressure regulator to the external actuation subsystem 160. Since fluid power can be adjusted remotely, operators no longer need to actively adjust the gland bolts, thus allowing shop personnel to maintain a safe distance from the rotating or non-rotating equipment. Further, many plant regulations do not allow mechanics near rotating elements after the pump has been started. This eliminates the use of packing as a viable sealing solution in certain applications. With the current invention, this device may be configured so the packing gland can be easily adjusted remotely (i.e. from a safe distance away).

The packing loading assembly 18 of the present invention provides for advantages over conventional pressure loading systems. The external actuation subsystem 160 can employ multiple actuation elements associated with each gland bolt. Specifically, the actuation elements of the external actuation subsystem 160 can be disposed on opposed sides of the gland bolt 90. The external actuation subsystem 160 can be employed to apply a relatively uniform axial loading force to the packing elements 110. The external actuation subsystem 160 can be employed with conventional gland bolts and follower elements and can be mounted without completely disassembling the sealing equipment. The use of multiple actuation elements per gland bolt helps to provide additional axial biasing forces in applications that require such enhanced live loading of the packing elements 110. Further, the use of multiple external actuation subsystems 160 provides for enhanced axial biasing forces that can be applied to the packing elements without the need for employing higher pressure fluid. For example, the fluid pressure can be equal to or less than 100 psi (e.g., about 6.9 bars).

The top and bottom housing components 164, 170 of the external actuation subsystem 160 illustrated in FIGS. 10A-11 can be configured to nest or be seated adjacent to the gland bolt 90, where the head of the gland bolt secures the external actuation subsystems 160 directly to the gland element 150. Alternatively, the housing components can be configured to include openings that seat the gland bolt 90. The housing components 164, 170 of the external actuation subsystems 160 shown in FIGS. 10A-10D are configured to directly seat the gland bolt 90, such that the external actuation subsystems 160 are coupled to the shaft of the gland bolt 90. Consequently, the gland bolt 90 secures the external actuation subsystems 160 to the gland element 150.

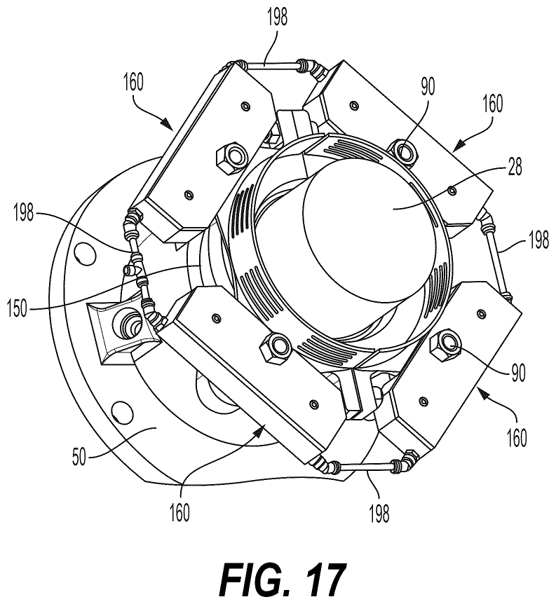

FIG. 17 illustrates an example embodiment of a packing loading assembly 18 employing a plurality of external actuation subsystems 160 mounted about a plurality of gland bolts that are fluidly coupled together. According to the illustrated example embodiment, four external actuation subsystems 160 are coupled to the gland element 150 by way of four gland bolts 90. The external actuation subsystems 160 are fluidly coupled together, in series, by the fluid conduits 196. The fluid conduits 196 can be fluidly coupled to the fluid source 12 in order to apply pressurized fluid to the external actuation subsystems 160.

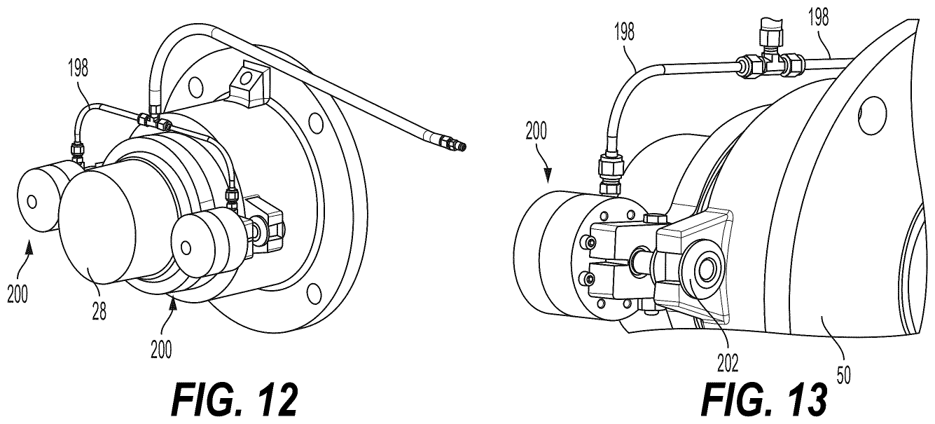

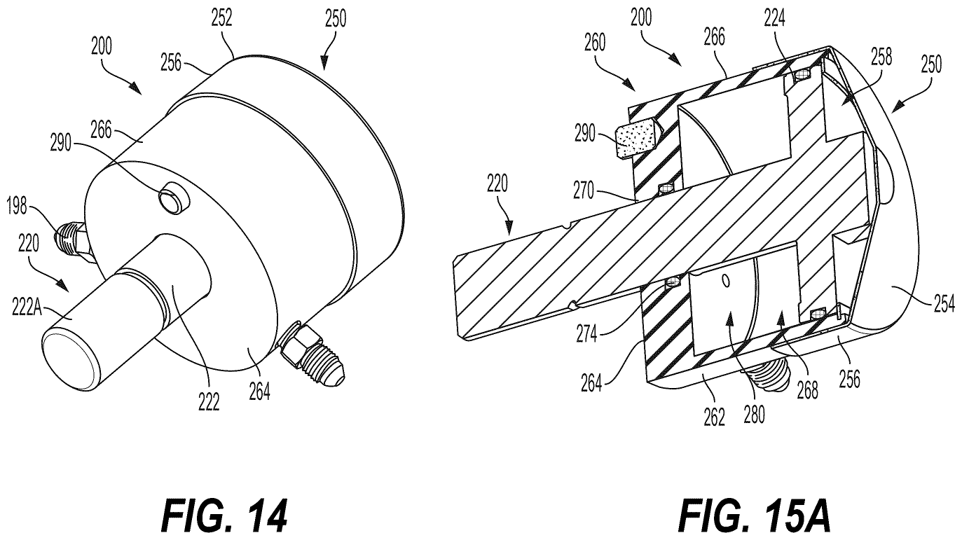

Another embodiment of the packing loading assembly 18 of the present invention is shown for example in FIGS. 12-16. Like reference numerals indicate like parts throughout the various views. The illustrated packing loading assembly 18 employs an external actuation subsystem 200 that employs the gland bolt as part of the actuation portion of the subsystem. Specifically, the external actuation subsystem 200 can move axially along the shaft of the gland bolt when moving between the preloaded and loaded positions. The illustrated packing loading assembly 18 includes a gland element 210 that is coupled to the stationary equipment 50 by way of a series of fastening elements, such as gland bolts 220. The gland bolt 220 has a shaft portion 222 and a head portion 224 coupled at one end to the shaft portion 222. The peripheral portion of the head portion 224 has a groove 226 formed therein that seats a sealing element 228, such as an O-ring. The illustrated gland element 210 has a main body that has a fastener receiving aperture 212 formed in a top portion 214 for receiving at least a portion of the shaft portion 222 of the gland bolt 220. The fastener receiving aperture 212 extends completely through the gland in an axial direction to allow the gland bolt 220 to pass therethrough and to connect to the stationary equipment 50. The top portion 214 of the gland element 210 has a top surface for contacting a surface of the external actuation subsystem 200 and a bottom flange portion 216 for contacting the axially outermost one of the packing elements 110 for applying an axial biasing force thereto. The illustrated stationary equipment 50, which can include for example the housing of a pump, has a movable shaft 28 that extends outwardly therefrom and includes a process fluid that needs to be sealed within the pump housing. The shaft 28 can either rotate or can move linearly (e.g., reciprocate) relative to the stationary equipment. The stationary equipment 50 can include a main body 52 that has a plurality of fastener receiving apertures 54 formed therein. The fastener-receiving aperture 54 can include an optional insert element 202 that has a central opening 204 formed therein that seats a terminal end portion 222A of the shaft 222 of the gland bolt 220. The terminal end portion 222A can be tapered or can have a stepped configuration, where the end portion 222A has a diameter that is smaller than the diameter of an intermediate portion of the shaft portion 222.

The main body 52 of the stationary equipment 50 also has a radially inner channel 56 formed therein having a bottom surface or flange portion 58 and an axially extending wall surface 60. The channel 56 seats the packing elements 110, such as a series of ring like packing elements that form a seal between the shaft 28 and the main body 52 of the stationary equipment 50 so as to seal the process fluid therein. The packing loading assembly 18 can also include an optional sleeve element 146 that is coupled to the shaft 28 and rotatable therewith. The sleeve element 146 is disposed between the packing elements 110 and the shaft 28. The sleeve element 146 can function as a protective barrier and a sealing interface between the shaft 28 and the packing elements 110, thus ensuring effective sealing while preventing the leakage of fluids from the stationary equipment 50. The channel 56 can also seat if desired or necessary one or more optional bushings or bearing elements to help prevent one or more of the packing elements 110 from accidentally extruding from the channel 56. Hence, in operation, the packing elements 110 help form a seal between the stationary equipment and the sleeve element 146 or shaft 28. The main body of the stationary equipment 50 has a top surface 52A and an opposed bottom surface. Those of ordinary skill in the art will readily recognize that the housing of the stationary equipment can have any selected configuration, and that the currently illustrated configuration is for purposes of illustration.

The channel 56 formed in the stationary equipment 50 can also seat an optional support element, such as a lantern ring 230. The lantern ring 230 can be disposed between the bottom surface 58 of the channel 56 and the packing elements 110. The lantern ring 230 helps axially position the packing elements 110 in the groove 56 and helps maintain the correct axial and radial alignment of the packing elements 110, ensuring that they are in the proper contact and alignment to effectively seal the equipment. The lantern ring 230 can also offer radial support to the packing elements 110. The radial support helps prevent excessive deflection or misalignment of the sealing surfaces or faces of the packing elements, which can occur due to operational forces and vibrations in the equipment. Proper radial support contributes to the longevity and performance of the mechanical seal. The lantern ring 230 can also stabilize the packing elements 110, especially in applications where there may be some degree of misalignment or shaft deflection.

The packing elements 110 can be compressed within an annular space formed by the channel 56 of the stationary equipment 50 (e.g., the stuffing box) that is disposed around the shaft 28. The gland bolts 220 can be used in combination with the external actuation subsystem 200 and the gland element 210 to compress the packing elements 110 in the channel 56 to form a fluid-tight seal to the sleeve element 146. As the packing elements 110 wear, the axial biasing load decreases over time and fluid leakage about the shaft increases, such that gland bolt adjustments or axial pressure applied to the packing elements 110 are required on a more regular basis. The conventional biasing elements, such as springs, of various conventional configurations and designs have been used to maintain a biasing load on the packing elements 110 during adjustment periods. However, the load decreases as the springs elongate, and the axial travel is limited. Thus, conventional biasing approached have significant drawbacks and limitations.

A basic principle of operation of the third embodiment of the packing loading assembly 18 of the present invention is to employ an external actuation subsystem 200 that functions as a fluid power actuator that is mounted externally to the gland element 150 and mounted on and about the gland bolt 220. The external actuation subsystem 200 functions to bias the gland element 210 in an axial direction against the packing elements 110. The actuation portion of the external actuation subsystem 200 is activated by an externally regulated pressure source supplying pressurized fluid, such as for example compressed air, nitrogen, or water. The pressure regulator 16 can be used to adjust the axially force applied to the gland element 210, and thus can essentially adjust the uniform load transmitted and applied to the packing elements 110.

The external actuation subsystem 200 of the present invention is shown for example in FIGS. 12-16. The illustrated external actuation subsystem 200 is mounted about the gland bolt 220 and is configured to be axially movable along the shaft 222 of the bolt 220 as a function of, or based on, the pressure of the fluid introduced into the external actuation subsystem 200 from the fluid source 12. According to one embodiment, the external actuation subsystem 200 includes a housing 242 forming a first or top housing component 250 and a second or bottom housing component 260. The top housing component 250 can have any selected shape, and according to one embodiment, has a circular shape. The bottom housing component 260 has a shape similar to or complementary to the top housing component 250. The top housing component 250 has a main body 252 that includes a top portion 254 and a sidewall 256 forming a chamber 258. The top housing component 250 is sized and configured to couple to and to overlie the bottom housing component 260.

The illustrated bottom housing component 260 has a main housing 262 that has a floor or bottom portion 264 and a sidewall 266 forming a chamber 268. The chamber 268 can be sized and configured to seat the head portion 224 of the gland bolt 220. Specifically, the sealing element 228 mounted in the groove 226 of the bolt head portion 224 engages with the inner surface of the sidewall 266 to form a fluid-tight seal. The outer diameter of the sidewall 266 of the bottom housing component 260 is smaller than the inner diameter of the sidewall 256 of the top housing component 250 to enable the bottom housing component 260 to seat and nest within the top housing component 250. Further, the inner diameter of the sidewall 266 of the bottom housing component 260 is larger than the outer diameter of the bolt head 224, such that the bottom housing component can freely move axially along the gland bolt. The bottom housing component 260 can also include an optional housing sealing element 248 for providing a secondary seal between any combination of the bottom housing component 260, the head of the gland bolt, and the top housing component 250. The housing sealing element 248 can be mounted within an optional groove formed adjacent to the terminal end or rim of the sidewall 266. Alternatively, the housing sealing element 248 can be seated on the rim of the sidewall 266 to forma seal between the housing components.

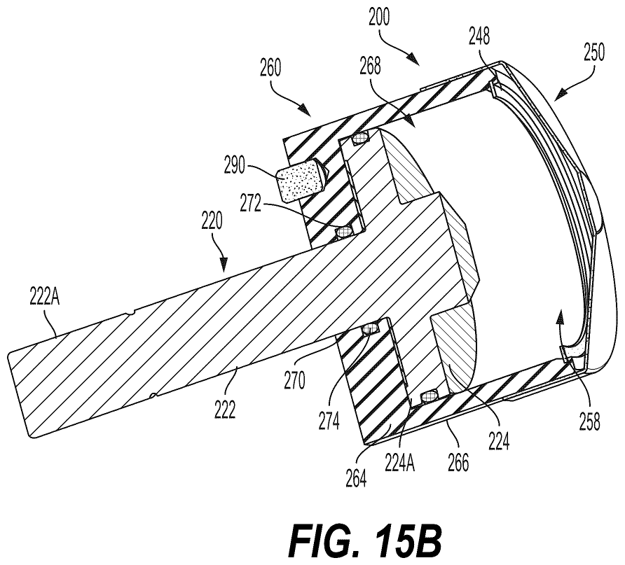

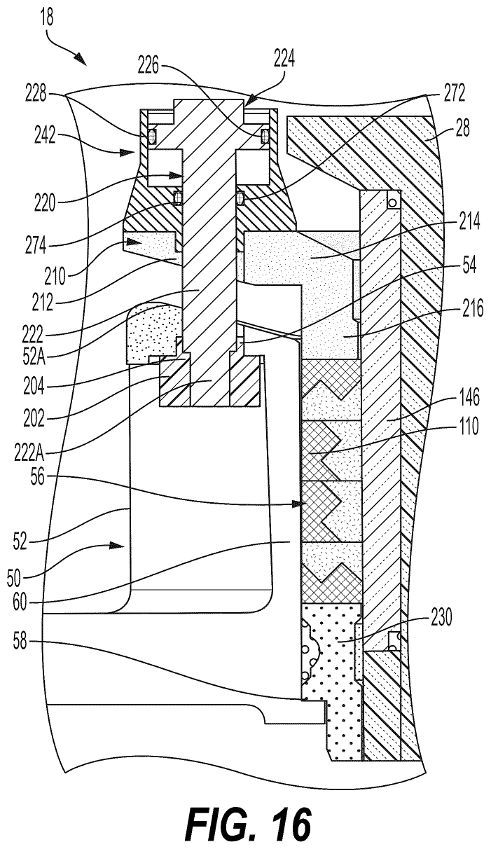

Further, the floor 264 of the bottom housing component 260 has a central opening 270 formed therein that is sized and configured to seat a portion of the shaft 222 of the gland bolt 220. The opening 270 also has a groove 272 formed therein that seats a sealing element 274. The sealing element 274 contacts an outer surface of the bolt shaft 222 and forms a fluid-tight seal such that any pressurized fluid within the chamber 268 is sealed therein and does not leak past the sealing element 274. The bottom portion 264 of the bottom housing component 260 can also be configured to seat an anti-rotation element 290 that can seat or mount within a corresponding hole formed in the gland to prevent the external actuation subsystem 200 or the bottom housing component 260 from accidentally rotating during use. When the top housing component 250 and the bottom housing component 260 are assembled together, the head portion 224 of the bolt is encased within the chamber 268 and the head portion 224 and the bottom or floor portion 264 of the bottom housing component 260 define a fluid gap or space 280 within the chamber 268. The axial travel of the head portion 224 within the chamber 268 is defined by the height of the chamber 268 in the external actuation subsystem 200. The bottom housing component 260 can also have a fluid port 282 formed therein. The fluid port 282 can be formed either in the sidewall 266 of the bottom housing component 260 or in the floor portion 264. According to one embodiment, the sidewall 266 has a fluid port 282 formed therein and communicates with the fluid gap 280. The fluid port 282 can be coupled to an external fluid conduit 198, such as a fluid supply pipe, for conveying a charging or actuation fluid to the fluid gap 280. Prior to charging the external actuation subsystem 200, the external actuation subsystem 200 is disposed in the preloaded position as shown in FIG. 15B where the head portion 224 of the gland bolt 220 is adjacent to or contacts the bottom portion 264 of the bottom housing component 260. The fluid gap 280 is defined by the underside of the head portion 224 and the bottom portion 264, and optionally the sidewall 266 depending upon the specific axial position of the head portion 244 within the chamber 268. According to one embodiment, the underside of the head portion 224 can have a lip potion 224A formed therein that separates the head portion 224 from the floor 264. The lip portion 224A can optionally include a fluid passage (not shown) that communicates with the fluid port 282 to enable the fluid to pass through the fluid port 282 and the fluid passage and into the fluid gap 280. When the external actuation subsystem 200 is sufficiently charged by the introduction of pressurized fluid into the fluid gap 280, the fluid pushes against the underside of the head portion 224 such that the external actuation subsystem 200 moves axially downwardly along the shaft 222 of the gland bolt 220 into engagement with the gland element 210. The underside of the bottom portion 264 of the bottom housing component 260 contacts the gland element 210 and applies an axial biasing force thereto. The flange portion 216 of the gland element 210 pushes axially downwardly on the packing elements 110 to apply an axial biasing force thereto, as shown in FIGS. 15A and 16.

In operation, the external actuation subsystem 200 can be mounted about the gland bolt 220 by passing the bolt shaft 222 through the opening 270 in the bottom housing component 260 and seats the head portion 224 within the chamber 268. The top housing component 250 is then seated on top of the bottom housing component 260 and secured thereto, thus retaining or capturing the head portion 224 of the gland bolt 220 therebetween. The gland bolt shaft 222 passes through the fastener receiving aperture 212 formed in the gland element 210 and the terminal end 222A of the shaft seats within the fastener receiving aperture 54 formed in the stationary equipment 50. The flange portion 216 of the gland element 210 is disposed adjacent to and preferably contacts the axially outermost one of the packing elements 110 to apply an axial biasing force thereto. When the external actuation subsystem 200 is initially mounted in the packing loading assembly 18 or when the process medium has a pressure higher than the pressure within the fluid gap 280 of the external actuation subsystem 200, the external actuation subsystem 200 is disposed in a preloaded position, as shown in FIG. 15B. The fluid source 12 then applies pressurized fluid through the fluid conduits 198 and through the fluid port 282 and into the fluid gap 280. The pressurized fluid has a pressure higher than the pressure of the process medium, and as a result the external actuation subsystem 200 moves axially downwardly along the shaft 222 of the gland bolt into the loaded position, as shown in FIGS. 15A and 16. The sealing elements 228 and 274 form a fluid tight seal and keep the pressurized fluid within the fluid gap 280. The bottom housing component 260 of the external actuation subsystem 200 pushes against the gland element 210, such that the flange portion 216 applies an axial biasing force to the packing elements 110.

The external actuation subsystem 200 can apply pressure to the gland element 210 to load the compression packing elements 110. The present invention improves upon existing products that live-load pump packing by providing a relatively constant force instead of a spring force that applies inconsistent and decreasing levels of force over time. The pressure regulating system 10 can employ commonly available fluids, such as compressed air or water, that can be supplied via a pressure regulator to the external actuation subsystem 200. Since fluid power can be adjusted remotely, operators no longer need to actively adjust the gland bolts, thus allowing shop personnel to maintain a safe distance from the rotating or non-rotating equipment. Further, many plant regulations do not allow mechanics near rotating elements after the pump has been started. This eliminates the use of packing as a viable sealing solution in certain applications. With the current invention, this device may be configured so the packing gland can be easily adjusted remotely (i.e. from a safe distance away).

The external actuation subsystem 200 of the present invention provides for a single external actuator that works in cooperation with the gland bolt to apply an axial biasing force to the packing elements 110.

The packing elements 110, also known as mechanical packing, packing assembly, pump packing or gland packing, are conventionally employed to form a partial fluid seal in mechanical or stationary equipment 50, such as a pump. The packing elements 110 forming the packing assembly can consist of packing material that is braided together in a rope form that can then be cut into segments or rings that are wrapped around the shaft 28 to fill voids and to control fluid leakage from the stationary equipment 50. The packing material forming the packing elements 110 can be formed from soft, non-metallic substances, such as PTFE, graphited or non-graphited acrylic, or other type of inert material, such as expanded PTFE or compressed graphite. The packing elements 110 can be compressed in the channel 56 of the stationary equipment 50 to form a stuffing box, creating a fluid seal by squeezing against the shaft 28 and a wall 60 of the channel 60. The compression of the packing elements 110 can be achieved by applying an axial load to the packing elements 110, either directly or indirectly, by the gland element 30, which helps limit fluid leakage around the shaft 28. The gland element 30 is typically tightened using fasteners or by using energized actuators (e.g., packing loading assembly 18) as described herein.

While mechanical packing is used in various industries due to its simplicity and low initial cost, the mechanical packing has selected drawbacks, such as higher leakage rates and the need for more frequent maintenance compared to other types of sealing devices, such as mechanical seals. The most common types of mechanical packing used in pumps can include braided packing material that can be made from selected types of packing materials, such as carbon, graphite, or synthetic fibers, PTFE packing, graphite packing, and aramid packing. The choice of packing material depends on factors such as the type of pumped fluid, temperature, pressure, and shaft speed. Mechanical packing also requires more frequent maintenance when compared to mechanical seals. For example, the mechanical packing is typically adjusted and replaced every few months, while mechanical seals can last multiple years without maintenance. The mechanical packing also requires monitoring to ensure proper operation and needs to be routinely adjusted (e.g., compressed) to control leakage rates and prevent burn out or excessive wear of the rotating components. Mechanical seals require little to no routine maintenance once properly installed. The frequent leakage associated with mechanical packing necessitates regular monitoring, adjustment, and cleanup, thus increasing maintenance labor compared to mechanical seals, while mechanical seals eliminate the need for frequent access to the stuffing box for adjustment or replacement of the packing assembly. These differences in maintenance frequency contribute to the long-term cost-effectiveness and reliability of mechanical seals despite their higher initial cost.

The present invention is also directed to another embodiment of the packing loading assembly of the present invention that is configured to automate and optimize the required attention needed to properly monitor, operate and maintain mechanical packing in stationary equipment, such as a pump, thus closing the gap between mechanical seals and mechanical packing in terms of maintenance and associated costs. The packing loading assembly of the present invention allows for the ability to accurately monitor and determine whether adjustment to the mechanical packing is required and can determine based on real-time data the time remaining for adjustment or replacement (e.g. days remaining before the mechanical packing needs to be adjusted or replaced). The present invention provides for significant advantages over conventional systems and approaches by minimizing equipment intervention and downtime, oversight by personnel, and allowing personnel to remain distant from moving equipment (i.e. rotating pump shafts). According to one embodiment, one or more machine learning models can be employed by the electronic device 22 to process sensor data (e.g., position or distance measurements) over time to determine the rate of consolidation (e.g., compression) of the mechanical packing and to determine or forecast the required packing maintenance timelines. The machine learning models can also utilize other available data, such as temperature, pressure and vibrational data, to further refine the machine learning models.

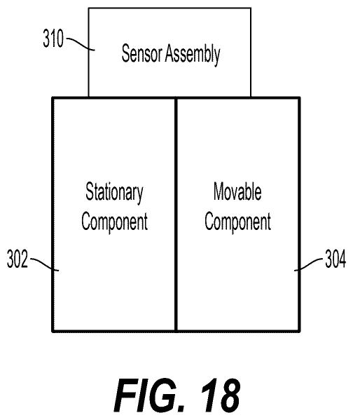

According to another embodiment of the present invention, a sensor assembly can be coupled to a packing loading assembly for determining a position of one or more components thereof. FIG. 18 is a simplified view of a sensor assembly 310 employed with the packing loading assembly 18 of the present invention. The packing loading assembly 18 can include, for the sake of simplicity, a stationary component or subsystem 302 and a movable component or subsystem 304. According to one embodiment, the packing loading assembly 18 can include a gland element, such as the gland elements 30, 150, and a biasing element, such as the follower element 70 or an external actuation subsystem 160, 200, that can be applied directly or indirectly to the packing elements 110. The sensor assembly 310 is coupled to both the stationary component 302 and the movable component 304 and can include a position sensor that can generate sensor data indicative of the physical state, position, and movement of one or more components of the packing assembly, including the relative position of a movable element with respect to a stationary element, such as a gland element relative to a stationary reference surface or a movable housing component relative to a stationary housing component forming part of the external actuation subsystem. The movement of the movable component 304, such as a gland element or a movable housing element of the external actuation subsystem 200, can be correlated to the amount of compression applied to the packing elements 110, and can be further correlated to the amount of compression remaining to be applied to the packing elements 110. The position sensor can detect and measure the position and/or movement of an element or object in space. The position sensor can measure for example a linear or angular position and can be classified based on the working principles and applications of the sensor. As used herein, the term “position sensor” refers to any sensor, transducer, or sensing assembly configured to detect, measure, or otherwise determine a relative position, displacement, or change in position of a movable component with respect to a reference or stationary component, such as a stationary pump housing, frame, stuffing box, or other fixed structure. The position sensor can be arranged to measure axial movement of a gland, follower element, or other load-applying element relative to the stationary component in order to determine an amount of compression applied to the packing elements, as well as an amount of remaining available travel corresponding to additional compression that may be applied during subsequent adjustment or automated actuation. Examples of suitable positions sensors can suitable position sensors include linear position or displacement sensors (such as linear variable differential transformers (LVDTs), magnetostrictive sensors, potentiometric sensors, Hall effect sensors, and optical or capacitive linear encoders), proximity sensors (including inductive, capacitive, or acoustic proximity sensors), and time-of-flight (TOF) based sensors (including LiDAR sensors, ultrasonic sensors, TOF sensors, and optical sensors configured to determine distance based on propagation time of a transmitted signal). In operation, the position sensor generates an electrical, optical, or digital output signal representative of the detected distance or displacement between the movable component 304 and the stationary component 302, which signal may be proportional to absolute position, incremental position change, or both (e.g., sensor data). The output signal generated by the position sensor can be sampled by a controller or processor of the electronic device 22 to determine or compute gland displacement, packing compression, packing wear, and/or remaining adjustment capacity, and useful time remaining on the packing elements and may further be used as an input to control algorithms or machine-learning models for automated regulation of gland loading and predictive maintenance of the packing assembly.

The sensor data can be characterized as packing related data, in that the measured sensor values and parameters derived therefrom are directly or indirectly indicative of a compression state, wear condition, remaining compressible length, remaining adjustment capacity, remaining useful life, and progression toward an end-of-adjustment or end-of-life condition of the packing elements. The sensor data therefore provides a quantitative basis for determining applied packing compression, remaining available compression travel, remaining useful life of the packing elements, degradation trends of the packing material, and predicted serviceability of the sealing system. Such sensor data may be generated continuously, periodically, or on demand and may be transmitted to the electronic device 22 for processing, storage, display, and use in control, reliability modeling, and predictive maintenance algorithms. More particularly, the sensor data can include absolute distance measurements between the position sensor and a target surface, incremental displacement values over time, direction of movement, velocity or rate of position change, and derived compression values corresponding to gland advancement. In implementations employing an optical TOF sensor, the data may further include signal propagation time or phase information, reflected signal intensity or amplitude, confidence or quality metrics associated with each measurement, ambient light compensation values, and temperature readings internal to the sensor for calibration purposes. Where alternative sensor types are used, such as potentiometric or acoustic sensors, the data may include analog voltage or current levels, digital counts, echo timing information, or similar raw measurement outputs that are convertible to distance or position values. The sensor data may additionally be time-stamped and associated with operating context information, such as speed, pressure, temperature, vibration, or actuator state of selected machinery, such as a pump, to facilitate correlation, trend analysis, and machine-learning-based modeling. Collectively, such packing element related sensor data enables the electronic device 22 to determine or compute real-time compression states, estimate remaining adjustment capacity, remaining useful life, evaluate wear and degradation trends, generate user-interface displays, calculate hazard rates and remaining useful life, and support automated alerts and proactive maintenance scheduling for the packing assembly.

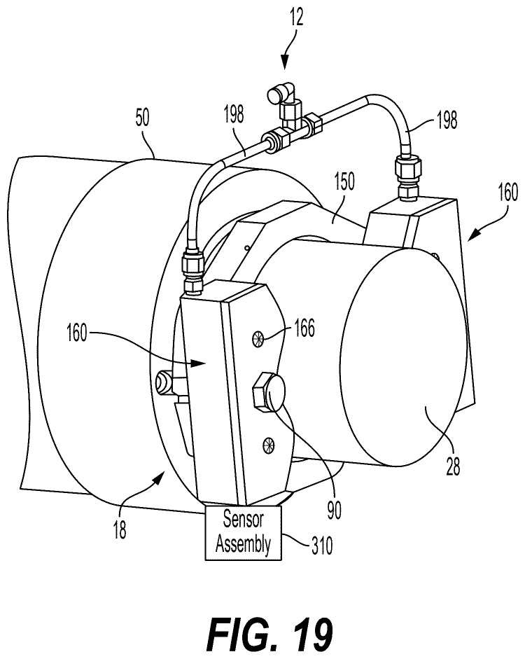

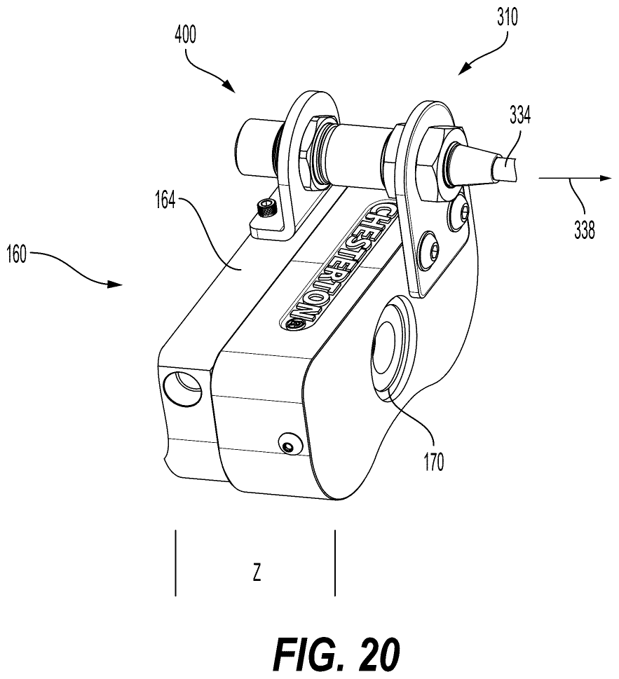

The sensor assembly 310 can be coupled to a gland element or can be coupled to either of the external actuation subsystems 160, 200. According to one embodiment, the sensor assembly 310 can be coupled to the external actuation subsystem 160. As shown for example in FIGS. 19 and 20, the sensor assembly 310 can be coupled to the external actuation subsystem 160. Specifically, one end of the sensor assembly 310 is connected to the top housing component 164 and the opposed end of the sensor assembly 310 is connected to the bottom housing component 170. As described herein, the movable bottom housing component 170 can be separated from the relatively stationary top housing component 164, and the sensor assembly 310 measures the distance between the top and bottom housing components. The bottom housing component 170 is configured to contact the gland element 150 and to apply a compressive axial biasing force to the packing elements 110. The amount of consolidation or compression applied to the packing assembly can correspond to movement in a Z dimension or axial direction.

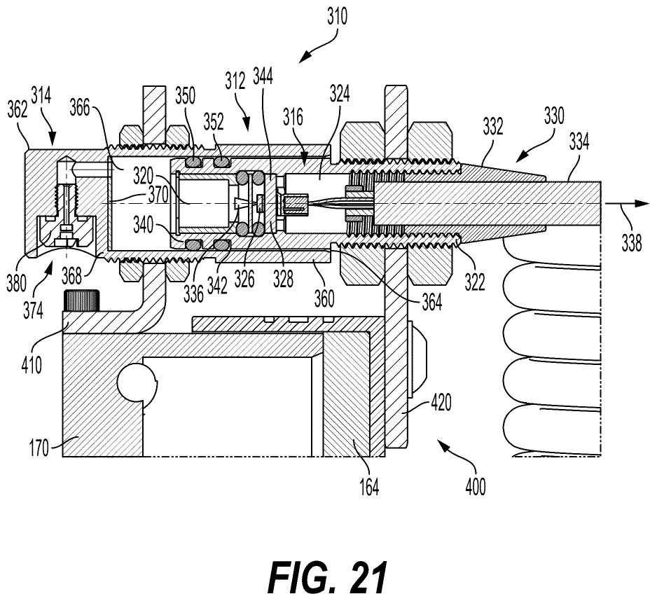

According to one embodiment, as shown in FIG. 21, the illustrated sensor assembly 310 has a main housing 312 that can include two or more telescoping housing components, such as a first main housing component 314 and a second main housing component 316. The outer first main housing component 314 is configured to have an opening that is sufficiently larger than an outer dimension or extent of the second main housing component 316. This dimensional arrangement allows the second main housing component 316 to move axially and freely inside the first main housing component 314, enabling telescoping movement between the two components. This telescoping capability provides for and accommodates the relative movement between the housing components required for accurate position sensing, as the housing components maintain effective alignment and protection for an internal position sensor while permitting necessary axial displacement during operation. The second main housing component 316 has a first opening 320 formed at a first end and a second opening 322 formed at an opposed second end. The second opening 322 can be threaded so as to couple to a sensor cable assembly 330. The sensor cable assembly 330 can include a connector component 332 that seats an electrical cable 334. The second main housing component 316 can have an internal chamber or passageway 324 formed therein for seating the cable assembly 330 and for seating the position sensor 326. The position sensor 326 can be coupled to any suitable support element 328, such as a circuit board, which in turn can be coupled to the electrical cable 334. The electrical cable 334 can provide power to the positions sensor 326 and can also convey or carry the output signals of the sensor. The output signals are indicative of the change of position of the second main housing component 316. A protective optical element 344, such as a lens, can be employed and can be positioned in front of the position sensor 326 to provide both optical conditioning and environmental protection. The protective optical element 344 can be configured to transmit radiation (e.g., light) emitted and received by the position sensor 326 while shielding the sensor from mechanical impact, vibration, moisture, dust, corrosive vapors, and process fluids commonly present in pump and packing environments. In addition to serving as a physical barrier, the protective optical element 344 can be shaped and optically configured to collimate, focus, or otherwise condition the emitted and/or reflected radiation to improve signal strength, reduce beam divergence, minimize optical aberrations, and enhance measurement accuracy and repeatability over a defined sensing range. The protective optical element 344 can further include suitable surface treatments or coatings, such as anti-reflective, scratch-resistant, hydrophobic, oleophobic, or anti-fouling coatings, to reduce signal loss and mitigate contamination-induced measurement drift. In this manner, the protective optical element increases the operational reliability, service life, and measurement stability of the position sensor while maintaining optical performance suitable for precise determination of relative displacement between the movable and stationary components of the packing assembly. The protective optical element 344 can be secured or retained in place by suitable supporting and retaining structure, as shown. The outer surface of the second main housing component 316, at the first end, can have one or more grooves formed therein for seating a sealing element. For example, the outer surface of the second main housing component 316 can have first and second axially spaced grooves 340, 342 that are sized and configured for seating the sealing elements 350, 352, respectively. The sealing elements form a seal between the first and second main housing components.

The illustrated first main housing component 314 has a main body having an opening 364 formed at a first end 360 and has an optional closed second end 362. The opening 364 forms a chamber 366 within the interior of the main body. The second main housing component 316 is configured to telescopically slide within the chamber 366. The chamber 366 has a floor or wall portion 368 formed at the second end 362. The wall portion 368 functions as a surface to reflect back signals generated by the position sensor 326. The wall portion 368 can also include an optional optical element 370 that can be formed from a suitable optically transmissive material. For example, the optical element 370 can be formed from any suitable optically transmissive material having suitable optical transmission characteristics at the operating wavelength of the sensor and sufficient mechanical and chemical durability for the intended environment. The optical element 370 can thus function as a protective optical window that permits transmission of emitted and reflected optical radiation emitted and used by the position sensor 326 while physically isolating the sensor from the environment within the chamber 366 of the housing 312 and any contaminants contained therein. According to one embodiment, the optical element 370 can be formed from, for example, polytetrafluoroethylene (PTFE), which has a relatively high chemical inertness, low surface energy, and resistance to fouling, abrasion, and corrosion. As such, the optical element when formed from this material inhibits adhesion and accumulation of liquids, particulates, hydrocarbons, and chemical residues that can otherwise attenuate or distort the signal of the position sensor 326. Additionally, the optical element when formed from PTFE provides a substantially stable refractive interface over a wide temperature and pressure range, thereby improving measurement repeatability and long-term accuracy of the distance or position determination. In this manner, the optical element 370 enables reliable optical coupling between the position sensor and the movable housing components being measured, while protecting the position sensor from mechanical damage, moisture ingress, and chemical exposure commonly present in pump and packing environments. In embodiments where the position sensor comprises an optical time-of-flight (TOF) sensor operating at or about a wavelength of 940 nm, the optically transmissive PTFE material may further be selected or processed to exhibit substantially Lambertian reflective characteristics at the operating wavelength. In particular, such PTFE material can provide diffuse reflection that closely approximates an ideal Lambertian surface, such that incident optical energy is reflected with substantially uniform intensity over a wide range of angles relative to the surface normal. In addition, the PTFE material can exhibit a total hemispherical reflectivity exceeding approximately 99 percent at the 940 nm wavelength, thereby returning or reflecting a high proportion of the transmitted optical signal back toward the TOF sensor independent of angular misalignment, surface finish variations, or minor positional tolerances. This combination of high diffuse reflectance and Lambertian behavior improves signal-to-noise ratio, reduces sensitivity to surface orientation and contamination, and enhances measurement stability and repeatability of the sensor when determining the relative position of the movable housing components, the applied compression of the packing elements 110, and the remaining available compression travel. Examples of suitable materials, in addition to PTFE, for the optical element 370 include other types of fluoropolymers (in addition to PTFE) such as fluorinated ethylene propylene (FEP), perfluoroalkoxy alkane (PFA), or ethylene tetrafluoroethylene (ETFE), optical-grade glass, borosilicate glass, fused silica or quartz, sapphire, polycarbonate, acrylic (PMMA), cyclic olefin copolymer (COC), cyclic olefin polymer (COP), or other transparent or translucent polymers and ceramics. Such materials may be selected based on factors including optical clarity, refractive index, resistance to chemicals or temperature, mechanical strength, abrasion resistance, and compatibility with the pumped fluid and surrounding atmosphere, while still providing an optical barrier that preserves accuracy and reliability of the sensor-based position measurements.

The illustrated first main housing component 314 can include an air vent 374 for allowing air to enter and exit the chamber 366 during relative movement of the first and second main housing components. The ability to allow air to enter and exit the chamber 366 helps reduce resistance formed between the housing components during movement. The air vent 374 can be formed by configuring one or more passages in the second end 362 of the first main housing component 314. The air vent 374 can communicate with the chamber 366. The sensor assembly 310 can employ a cap element 380 for selectively closing or plugging the air vent 374. The cap element can also optionally include a fluid passageway that can communicate with the air vent 374.

The illustrated sensor assembly can also include a securing assembly 400 for securing the sensor assembly to a gland element or to one of the external actuation subsystems 160, 200. In the illustrated embodiment, which is simply one example, the securing assembly 400 secures the sensor assembly 310 to the external actuation subsystem 160. The securing assembly 400 can include a first bracket element 410 that is coupled at one end to the first main housing component 314 and at an opposed end to the bottom housing component 170. The first bracket element 410 can be secured to the components by way of suitable fastening mechanisms, such as fasteners. The securing assembly 400 can also include a second bracket element 420 that is coupled at one end to the second main housing component 316 and at an opposed end to the top housing component 164. The second bracket element 420 can be secured to the components by way of suitable fastening mechanisms, such as fasteners.

According to one embodiment, the position sensor 326 is an optical time-of-flight (TOF) sensor. The TOF sensor 326 can be configured to determine a distance between the sensor 326 and a target surface, such as the optical element 370 formed at the second end 362 of the first main housing component 314, based on propagation time of an emitted optical signal. The first main housing component 314 can be coupled via the first bracket element 410 to the axially movable bottom housing component 370 and the second main housing component 316 can be coupled via the second bracket element 420 to the stationary top housing component 164. The TOF sensor can include a radiation source (e.g., light source), such as a laser diode or light-emitting diode, operable to emit one or more radiation beams, either pulsed, modulated or continuous, of electromagnetic radiation 336, for example in the near-infrared spectrum, and a photodetector (e.g., detector) arranged to receive the radiation reflected from the target surface. During operation, the TOF sensor transmits the optical signal 336 toward the target surface, such as the optical element 370, detects the reflected radiation beam, and measures a time interval between transmission and reception of the beam. The measured time interval is proportional to the round-trip travel time of the optical beam and, when multiplied by the speed of light and divided by two, yields a distance value corresponding to the separation between the TOF sensor and the target surface. When the target surface 370 moves towards the TOF sensor 326, such as when the first main housing component 314 moves towards the second main housing component 316 (e.g., when the bottom housing component 170 moves towards the top housing component 164), the separation distance between the sensor 326 and the target 170 decreases, resulting in a shorter propagation time for the emitted optical or radiation signal 336 to travel to the target surface and back to the photodetector. The TOF sensor 326 detects this reduced time interval and computes or determines a corresponding distance value representative of the current position of the target surface relative to the sensor. Conversely, when the target surface 370 moves away from the TOF sensor 326, such as when the first main housing component 314 moves away from the second main housing component 316 when the bottom housing component 170 moves away the top housing component 164, the separation distance increases, the round-trip propagation time increases, and the TOF sensor 326 senses, detects, or determines a larger distance value indicative of the new position of the target surface 370. In this manner, the TOF sensor 326 provides a direct measurement of absolute position (e.g., distance) and, by comparison of successive measurements, determines both the direction and magnitude of displacement or movement of the movable component relative to the stationary component. In the context of a packing assembly, movement of the target surface 370 toward the sensor 326 corresponds to a loosening or relaxation of the gland and reduced compression on the packing elements 110, whereas movement away from the sensor 326 corresponds to tightening or advancement of the gland and increased compression on the packing elements 110. The measured sensor data, which can include position or distance data, may be processed by a processor or controller of the electronic device 22 to determine or calculate applied compression, remaining adjustment capacity and time, remaining useful life of the packing elements 110, and overall packing wear, and to support automated control and predictive maintenance functions.

In certain implementations, the TOF sensor 326 can operate in a direct pulsed mode, in which discrete pulses of radiation are emitted and timed, or in a continuous-wave modulated mode, in which phase shift between transmitted and received signals is analyzed to determine position (e.g., distance). The resulting position or distance measurement can represent an absolute position of the movable component relative to a stationary reference or a change in position over time. The TOF sensor 326 can optionally include signal processing circuitry for filtering, ambient light compensation, temperature compensation, and linearization of the measured distance signal. The distance data produced by the TOF sensor 326 can be communicated to a controller of the electronic device 22, which can calculate gland displacement, packing compression, packing wear, and remaining available compression travel and time, and may further be supplied as an input to a control algorithms or machine-learning models for automated adjustment and condition monitoring of the packing assembly.

In operation, the sensor assembly 310 can be coupled to either a gland element or to an external actuation subsystem, such as, for example, to the external actuation subsystem 160, 200. When coupled thereto, and as shown for example in FIG. 21, the first main housing component 314 can be connected to the movable component, such as to the bottom housing component 170, via the first bracket element 410 and the second main housing component 316 can be coupled to the stationary component, such as to the top housing component 164, via the second bracket element 420. The second main housing component 316 is configured to slidingly engage with the first main housing component 314. Specifically, the first and second main housing components can telescopically move relative to each other in an axial direction. The sensor assembly 310 can employ a TOF sensor configured to determine a distance between the sensor and a target surface associated with the second end of the first main housing component 314 by measuring a propagation time of an emitted optical signal. The TOF sensor 326 can be actuated and emit a radiation beam 336 via a radiation or light source (e.g., radiation or light emitting diode) in a pulsed or continuous manner that is reflected back to the sensor via, for example, the optical element 370. The reflected light is sensed by a photodetector forming part of the sensor, and the sensor 326 can generate an output signal (e.g., sensor data) indicative of the position or distance of the first main housing component 314. The position sensor 326 measures or determines distance based on the measured round-trip travel time or phase shift between the transmitted and received radiation beams, thereby providing an absolute position measurement of the movable component relative to a stationary reference. In exemplary implementations, the TOF sensor 326 operates at wavelengths in an infrared range, such as in a near-infrared range. For example, the radiation source can operate between about 850 nm and about 950 nm, and preferably at about 940 nm, and provides a measurement range from about 1 mm to about 500 mm, more typically from about 5 mm to about 200 mm, with a resolution on the order of about 0.01 mm to about 0.5 mm and an accuracy on the order of about ±0.1 mm to about ±1 mm, depending on configuration and environmental conditions. The sensor may also operate at sampling rates from about 1 Hz to about 10 kHz and may include compensation for ambient light, temperature variation, and signal noise. Such operating parameters enable reliable, real-time monitoring of gland position and packing compression in pump sealing assemblies.

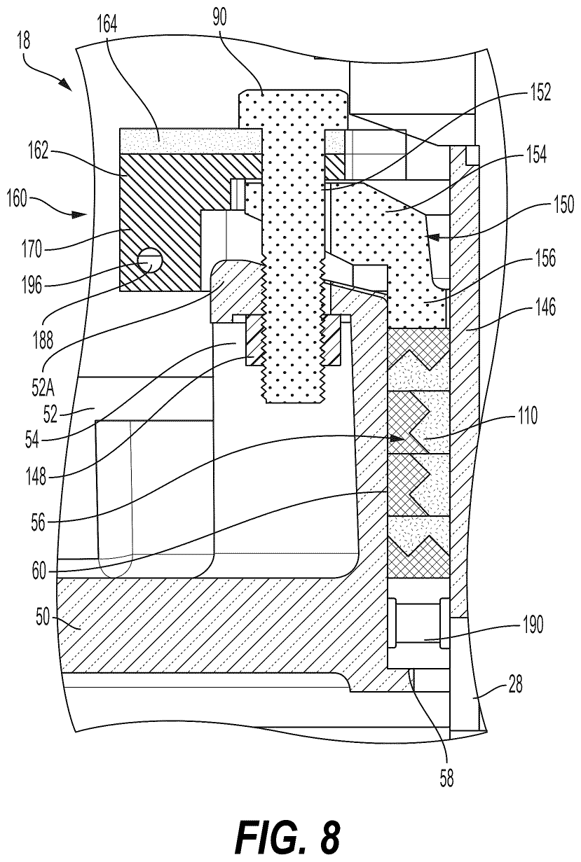

The power to and the output signals generated by the sensor 326 can be carried along the electrical cable 334. Since the first main housing component 314 is coupled to a gland element 150 (see FIG. 8), the axial movement of the first main housing component 314 away from the sensor 326 corresponds to increased compressive pressure or force applied to the packing elements 110 by the gland element 150. The information detected and measured by the sensor 326 can be conveyed to and processed by the electronic device 22. The position sensor 326 can ultimately determine the remaining gland nose dimension used to adjust the mechanical packing 110 in the stuffing box of the stationary equipment 50 (e.g. pump). The Z dimension denoted in FIG. 20 indicates this remaining dimensional value. The sensor assembly 326 and the electronic device 22 help monitor the Z dimension over time, and the sensor data generated by the sensor 326 can be processed by the electronic device 22 to determine when the Z dimension goes to zero. When the Z dimension is zero, there is no more adjustment that can be made to the mechanical packing elements 110 by the gland element, and as such, the packing elements need to be replaced. In a more simplistic manner, the Z dimension can be monitored continuously and/or instantaneously at any point in time so that maintenance activities can be determined and scheduled. The sensor data can be processed to predict the amount of time remaining before the Z dimension is zero. The use of the optical time-of-flight sensor 326 allows for high accuracy at very low power consumption in comparison to other sensor types.

Further, and optionally, the electronic device 22 can be configured to define a predetermined maximum amount or limit on distance travel that is less than the maximum amount of travel (e.g., Z=0) of the movable element during compression of the packing elements 110 over time. Specifically, the electronic device 22 can be preloaded with distance information that corresponds to a predefined range or maximum allowable amount of axial movement of the packing assembly or movable element indicative or representative of compression of the packing elements 110. Beyond this point, no further compression is permitted or feasible. This measurement defines the extent of axial movement for the packing assembly. The position sensor 326 can measure the current position of the gland element or other movable element and can correlate or compare the current position of the movable element to the predefined allowable amount of movement or to the maximum allowable amount of movement to determine a remaining amount of axial movement. The remaining amount of axial movement or remaining useful life can be correlated to selected time intervals, such as for example days, weeks, or months, or years. Accordingly, the measured current position of the movable element, which corresponds to a specific amount of packing compression, can be correlated to time. This allows the user to determine, in real time, how much compression remains in the packing elements before the packing assembly needs to be replaced. The position data, along with the estimated remaining useful life of the packing assembly, can be communicated to the user via the network 20.

The position sensor 326 described herein is shown in a closed housing. Those of ordinary skill in the art will readily recognize that the sensor can be used in an open configuration or open housing and need not be mounted in a closed configuration housing. The main housing components of the main housing 312 can be constructed from any suitable material proper for the environment, such as from metal, such as stainless steel, or from a plastic material. The configuration of the first and second main housing components can be selected so that the radiation beam generated and emitted by the position sensor 326 signal is accommodated therein. The radiation beam generated by the position sensor is this prevented from contacting the interior surface of the chamber so as to avoid generating erroneous signals.

The sensor assembly 310 can generate sensor data 338 that is conveyed to and processed by the electronic device 22. The electronic device 22 can include a processor, memory, and suitable storage for storing one or more software applications, including a control application. The control application can be configured to process the sensor data and then determine one or parameters associated with the packing elements or assembly and/or the pressure regulating system 10. The parameter associated with the packing assembly can include compression state. The sensor data may include, for example, absolute distance measurements between the sensor and a target surface, incremental displacement values, direction of movement, rate of position change over time, signal strength or signal quality metrics, timestamps, and optionally temperature or ambient light compensation values provided by the sensor. The electronic device 22 can be configured to execute one or more control applications, such as one or more machine-learning models stored in memory and executed by one or more processors, to analyze such position-related data in the sensor data 338 representing movement of the movable component relative to the stationary component. As used herein, the term “compression state” of a packing assembly or one or more packing elements refers to a quantitative and qualitative condition of the packing elements resulting from an amount of axial load applied by a gland or other load-applying component and the corresponding physical deformation, consolidation, and wear of the packing material forming the packing elements. The compression state may be characterized by one or more parameters derived from position sensor data, including, by way of non-limiting example, a current gland position relative to a stationary reference, a total amount of compression applied since installation, a remaining compressible length of the packing elements, a remaining adjustment margin of the gland, a rate of change of compression over time, a remaining useful life of the packing elements, and the like. The compression state further reflects whether the packing elements are under-compressed, within a desired operating compression range, or approaching an over-compressed or end-of-adjustment condition in which additional gland advancement would be ineffective or mechanically limited.

The compression state may also incorporate temporal and predictive aspects, including trends in gland movement, relaxation behavior, and packing consolidation, as well as model-derived estimates of remaining useful life, time to exhaustion of available compression travel, and probability of leakage or sealing degradation. Accordingly, the compression state represents not merely an instantaneous mechanical setting, but a multi-dimensional condition descriptor of the packing assembly that integrates present compression, historical adjustment behavior, and projected future capability to maintain sealing performance. In this manner, sensor-derived compression state information enables automated control, condition monitoring, reliability analysis, and predictive maintenance of the packing assembly within the pumping system.

The received sensor data 338 may be optionally filtered, normalized, and converted into displacement values representative of gland movement, which are then correlated to an amount of compressive load applied to the packing elements and to an amount of remaining available travel corresponding to additional compression that may be applied before a predefined mechanical limit or end-of-life condition is reached. Based on such processing, the electronic device 22 can determine and update one or more parameters associated with the packing elements 110 and/or the overall system 10, including, for example, a current compression value, a compression rate, an estimated packing wear state, a remaining compressible length of the packing elements, a remaining adjustment margin, a predicted time or operating cycles remaining until no further compression can be applied, a predicted time to replacement or maintenance, and a probability or likelihood of leakage or seal degradation. In implementations employing machine-learning models, historical sensor data, operating condition data (e.g., pressure, temperature, shaft speed, and the like), and prior maintenance events may be used as inputs to estimate future behavior and remaining useful life of the packing assembly.

The electronic device 22 can further generate one or more user interfaces for presentation on a local display, remote terminal, mobile device, or supervisory control system. Such user interfaces may present numeric values, trend plots or graphs, status indicators, and graphical representations of gland position, packing compression, remaining adjustment capacity and time, and predicted service life. For example, the electronic device can be configured to generate a user interface displaying at least one of, or any combination of, a current compression value, a remaining adjustment capacity, and a predicted time to replacement of the packing elements. Additionally, the electronic device 22 can be configured to generate alerts, alarms, control, or notifications when one or more parameters exceed or fall below predetermined thresholds, such as when remaining compressible travel drops below a minimum value, when predicted time to end-of-adjustment is within a defined time window, or when abnormal movement indicative of accelerated wear or failure is detected. The alerts may be communicated via visual indicators, audible alarms, network messages, or integration with plant control or maintenance management systems to facilitate condition-based maintenance and proactive servicing of the packing assembly.

In some embodiments, the electronic device implements one or more control applications, such as one or more machine-learning (ML) based predictive maintenance applications for estimating future condition and end-of-life behavior of the packing assembly based on historical sensor data. By way of example, the machine learning models may analyze time-series sensor data representing a measured distance between the TOF sensor 326 and a target surface, wherein the distance metric decreases over time as the gland advances and the packing elements undergo compression and wear. Such historical degradation data, optionally collected over extended operating periods (e.g., hundreds of days), may be used by the electronic device to learn patterns and rates of change associated with progressive packing consumption, loss of available compression travel, and approach to a mechanical limit or failure threshold corresponding to a “zero-distance” or minimum allowable distance condition.

In exemplary implementations, multiple modeling techniques may be employed in parallel or selectively to estimate a remaining useful life (RUL) of the packing elements 110 and to predict a time or date at which no further compression can be applied to the packing or at which sealing performance is likely to become unacceptable. Such modelling techniques can include deterministic parametric models, such as polynomial curve fitting applied to the sensor data 338, and specifically the distance-versus-time portion of the sensor data, to generate a point estimate of a predicted failure or end-of-adjustment time based on an extrapolated historical trend. Additional optional techniques may include probabilistic or Bayesian regression models that generate not only a predicted mean failure time but also a statistical confidence interval representing uncertainty in the prediction and an estimated time window during which the end-of-life condition is likely to occur with a predefined probability. Further, non-parametric models, such as Gaussian process regression models, may be used to flexibly model nonlinear degradation behavior in the packing elements without assuming a fixed functional form, thereby providing more conservative or robust predictions under variable operating conditions.

The machine learning models can generate model output data that can include, by way of example, an estimated remaining number of operating days or cycles until the available compression travel is exhausted, an estimated calendar date of end-of-adjustment or replacement, confidence bounds on such estimates, and a continuously updated RUL value derived from newly received sensor data 338. These predicted parameters may be stored in the storage element, displayed via the generated user interfaces, and used to trigger alerts or maintenance recommendations when the estimated remaining time or compression margin falls below predefined thresholds. In this manner, the system 10 enables condition-based and predictive maintenance of the packing assembly, reduces unplanned downtime, and improves reliability by proactively identifying approaching end-of-life conditions based on sensor-derived position data and machine learning based degradation modeling.

In some embodiments, the predictive maintenance functionality implemented by the electronic device 22 can be further integrated with one or more reliability engineering methodologies or techniques to improve robustness and decision-making with respect to maintenance planning for the packing assembly and associated pump components. In addition to regression-based degradation modeling, the electronic device 22 can employ survival analysis and reliability models to relate time-to-failure or time-to-end-of-adjustment to operating conditions and risk factors derived from the sensor data 338 and system telemetry. By way of example, a Cox Proportional Hazards model can be employed to correlate a hazard rate (e.g., failure rate) or probability of failure with explanatory variables, such as temperature, pressure, shaft speed, vibration, fluid properties, rate of gland adjustment, or environmental exposure, thereby enabling dynamic estimation of how changing operating conditions affect the likelihood of accelerated packing wear or loss of remaining compression capacity. The hazard rate thus represents a measure of the likelihood that the packing will fail at a particular point in time, given that the packing elements have operated without failure up to that point in time. More specifically, the hazard rate corresponds to an instantaneous probability per unit time that a failure event will occur at time t, conditioned on survival until time t, and therefore describes how the risk of failure evolves over the operating life of the component rather than representing a cumulative probability. In the context of a packing assembly, a relatively low hazard rate indicates that the packing elements are unlikely to reach an end-of-compression condition or unacceptable leakage state in the near term, whereas a high or increasing hazard rate indicates that the packing elements are approaching wear-out or exhaustion of available compression travel and that the likelihood of failure or loss of sealing performance is increasing. By way of example, the hazard rate may be elevated during early operation due to installation-related effects, remain relatively stable during a normal operating phase, and increase significantly as the packing elements approach the end of their usable service life. In models such as the Cox proportional hazards model, the hazard rate may be expressed as a function of time and one or more operating or environmental variables, including sensor-derived parameters such as gland position, compression rate, temperature, pressure, or shaft speed, thereby enabling dynamic estimation of the instantaneous risk of failure or of reaching a condition in which no further compression can be applied.

In further embodiments, the electronic device 22 can also optionally implement a Weibull regression or related lifetime distribution model to characterize failure behavior over different phases of the equipment lifecycle, including early-life failures, steady-state operation, and wearout conditions commonly represented by a “bathtub” reliability curve. Such models enable estimation of time-dependent failure rates and support classification of the packing assembly within a particular lifecycle phase based on observed position sensor trends and operating history. The outputs of these reliability-based models may be combined with the regression and machine-learning predictions described above to generate confidence intervals and risk-weighted estimates of remaining useful life.

These probabilistic outputs may be used by the electronic device 22 to support proactive maintenance planning, wherein service or replacement of the packing elements is scheduled in advance of a predicted end-of-adjustment or failure condition rather than in response to leakage or system failure. In particular, confidence interval data may be treated as a primary decision parameter, such that maintenance actions are recommended or automatically scheduled when a lower bound of a predefined confidence interval (e.g., a 95% interval) indicates that the remaining time to exhaustion of available compression travel or acceptable sealing performance is approaching a minimum threshold. For example, rather than scheduling maintenance at a single predicted failure time, the system 10 may recommend service prior to the earliest statistically likely failure window to reduce the probability of unplanned downtime. In this manner, the integration of machine-learning models with reliability engineering techniques enables risk-informed, condition-based maintenance strategies for the packing assembly and associated pumping system.

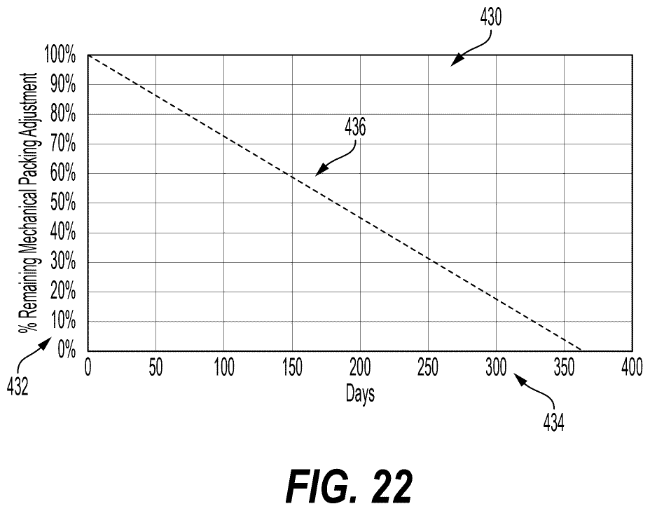

FIG. 22 illustrates an example packing adjustment plot or graph 430 that may be generated by the electronic device 22 based on position sensor data and derived compression values. The illustrated graph 430 charts or graphs an amount of compression or adjustment applied to the packing elements 110 along a vertical or Y-axis 432 as a function of time along a horizontal or X-axis 434, thereby representing progressive advancement of a gland or other load-applying element as the packing elements wear, relax, or consolidate during operation. In the illustrated embodiment, the plotted data 436 exhibits a substantially linear trend over the illustrated operating period, indicating a generally uniform rate of packing consumption and corresponding gland advancement under stable operating conditions. Using this historical trend as an input to one or more predictive models, including regression-based techniques and/or machine learning models as described herein, the electronic device 22 extrapolates the compression-versus-time relationship to estimate a future point at which a predefined maximum compression limit, minimum allowable distance, or end-of-adjustment condition will be reached, corresponding to exhaustion of the usable compressible length of the packing elements 110. In the example shown, the electronic device 22 predicts that the packing elements will reach such an end-of-useful-life condition within a forecast window of approximately 350 to 400 days from initial installation. In further embodiments, the graph 430 may additionally display confidence bands, hazard-rate indicators, or remaining-useful-life values generated by the predictive maintenance algorithms, and may be updated in real time as additional position sensor measurements are acquired, thereby enabling ongoing assessment of packing wear and proactive scheduling of maintenance prior to loss of sealing performance or inability to apply further compression. Those of ordinary skill in the art will readily recognize that the graph 430 need not be linear.

The illustrated position sensor 326 can be configured to determine a remaining gland nose dimension (Z), corresponding or correlated to a distance between a movable element (e.g., a gland component or a movable component of the external actuation subsystem) and a stationary reference surface (e.g., a pump housing or a stationary component of the external actuation subsystem), which is representative of an amount of compression already applied to the packing elements and an amount of compression remaining to be applied. Measurement of the Z dimension enables accurate, quantitative monitoring of packing adjustment over time and supports prediction of packing replacement or end-of-adjustment timing. The electronic device 22 can perform such monitoring on a continuous basis or on demand, thereby providing real-time or near-real-time status information suitable for maintenance planning and condition-based servicing. Linear displacement measurements may be obtained using, for example, any suitable type of position sensor, such as optical time-of-flight (TOF) sensors, potentiometric sensors, or acoustic-based sensors, thereby enabling automated monitoring without requiring manual measurement or physical inspection by personnel.

In further embodiments, an optical TOF sensor can be employed to provide high positional accuracy, for example on the order of less than approximately one millimeter, while maintaining low power consumption and a compact physical footprint suitable for integration within confined pump and stuffing box environments. The TOF sensor can be configured for direct distance measurement to a target surface or indirect measurement via an intermediate reflective element, thereby providing flexibility in sensor placement and configuration to accommodate different mechanical layouts and environmental constraints. The sensor assembly 310 may further include protective packaging, such as sealed telescoping tubes, O-rings, and other sealing features, to prevent ingress of fluids, particulates, and debris and to maintain reliable performance in harsh industrial environments. In some embodiments, the sensor electronics are mounted on a concentric printed circuit board (PCB) and encapsulated or potted to protect conductive traces, components, and cabling from vibration, moisture, and chemical exposure.

The sealed sensor main housing 312 can additionally include one or more inlet or outlet valves 374 configured to equalize or relieve internal air pressure during telescopic movement of the main housing components of the sensor assembly 310, thereby reducing mechanical resistance to motion and improving measurement repeatability and long-term stability. Sensor-derived distance data may be combined with additional measurements, such as vibration data, temperature, or operating parameters, and processed by predictive algorithms or machine-learning models to project maintenance timelines, estimate remaining useful life of the packing elements, and support proactive servicing strategies. The system 10 may further generate a simplified maintenance signal or status output, such as a digital flag, analog signal, or network message, indicating when predefined service thresholds are reached, thereby improving operational safety and reducing the need for personnel to approach rotating equipment or perform frequent manual inspections.

As used herein, the term “machine learning” or “machine learning model” or “model”, whether in singular or plural form, is intended to mean or refer to the application of one or more software application based techniques that process and analyze data to identify patterns and to generate inferences, predictions, classifications, decisions, and/or recommendations based on the patterns in the data. The machine learning techniques may include a variety of models and algorithms, such as supervised learning, unsupervised learning, reinforcement learning, semi-supervised learning, deep learning, and natural language processing (NLP) techniques, including natural language generation (NLG) and generative language models. The machine learning models are typically trained using training data. The training data is used to optimize the parameters of the model, such as the weights in a neural network. As such, the better the training data, the more accurate and effective the machine learning model can be. In the case of supervised learning, the training data includes labeled examples (i.e., input-output pairs) that allow the model to learn a mapping from inputs to target outputs. Common tasks performed by supervised learning models include classification and regression. Unsupervised learning models are trained on unlabeled data and are configured to identify hidden patterns, structures, or groupings in the data. Common unsupervised learning tasks include clustering and dimensionality reduction. Semi-supervised learning techniques combine elements of supervised and unsupervised learning by utilizing a small amount of labeled data in conjunction with a larger volume of unlabeled data to improve model performance. The semi-supervised learning models combine elements of both supervised and unsupervised learning models, utilizing limited labeled data alongside larger amounts of unlabeled data to improve model performance. Reinforcement learning involves training an agent to take sequential actions within an environment to maximize a reward signal. The agent learns through trial and error by receiving feedback in the form of rewards or penalties based on its actions. Deep learning is a subfield of machine learning that utilizes neural networks with multiple layers to automatically learn hierarchical feature representations from data. A neural network includes a plurality of interconnected nodes (or “neurons”) organized into layers, where each connection is associated with a weight that determines the strength of the signal passed between neurons. The weights are updated during training to minimize prediction error and improve performance. By adjusting these weights based on input data and desired outcomes, neural networks can learn complex patterns and relationships within the data. Examples of neural networks used in deep learning include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), and transformer-based architectures. Transformer-based models, including large language models (LLMs), are configured to process and generate human language by learning contextual relationships between tokens in a sequence. These models are typically pre-trained on large corpora of text using self-supervised learning techniques and can perform a wide range of language-related tasks, such as text generation, translation, summarization, question answering, and sentiment analysis. The large language models (LLMs) may include, or be implemented as, generative artificial intelligence (AI) models that are capable of generating coherent and contextually appropriate text responses based on input prompts. LLMs can be configured to understand and generate human language by learning patterns and relationships from large datasets. These models may utilize deep learning techniques, particularly transformer architectures, to process and generate text. LLMs can be pre-trained on massive corpora of textual data using self-supervised learning techniques and may perform tasks such as text generation, language translation, summarization, sentiment analysis, question answering, and other natural language processing tasks.

A transfer learning model can involve training a model on a first task and subsequently applying the learned parameters or representations to a second, related task, thereby enhancing training efficiency and model performance. An ensemble learning model can combine the outputs of multiple individual models to improve overall predictive accuracy. Common ensemble techniques include bagging, boosting, and stacking. An online learning model can be incrementally updated as new data becomes available, making such models suitable for real-time or dynamic environments. An instance-based learning model can generate predictions based on similarity measures between new input instances and previously observed training instances.

The machine-learning processes described herein may be utilized to generate machine-learning models. As used herein, a machine-learning model refers to a mathematical representation of a relationship between one or more inputs and corresponding outputs, generated using any machine-learning technique, including without limitation any of the processes described above, and stored in memory. Once created, a machine-learning model may receive one or more input values and produce a corresponding output based on the learned relationship derived during training. For example, and without limitation, a linear regression model generated using a linear regression algorithm may compute a linear combination of input features using coefficients learned during training to generate an output value. As a further non-limiting example, a machine-learning model may be implemented as an artificial neural network, such as a convolutional neural network (CNN), comprising an input layer of nodes, one or more hidden (intermediate) layers, and an output layer of nodes. Connections between nodes may be established and weighted through a training process in which data from a training dataset are applied to the input layer. A training algorithm—such as Levenberg-Marquardt, conjugate gradient, simulated annealing, or other optimization algorithms—may be used to iteratively adjust the connection weights between nodes in adjacent layers to minimize prediction error and produce desired outputs at the output layer. This type of approach may be referred to as deep learning.

As used herein, the term “generative model,” “generative AI model” or “generative language model”, whether in singular or plural form, is intended to mean or refer to a category of machine learning models configured to generate new outputs based on data on which the models have been trained. Generative models may produce new content in various modalities, including text, images, audio, code, simulations, and the like. Generative language models specifically focus on generating natural language text and are typically based on deep learning neural networks, such as large language models (LLMs) employing transformer architectures. These models learn patterns and relationships within training data and generate new language content based on the learned representations. Generative models may include, without limitation, generative adversarial networks (GANs), which consist of two neural networks trained adversarially to generate realistic images, audio, or other data types; variational autoencoders (VAEs), which learn latent representations of data for generation tasks; and deep convolutional GANs (DCGANs), which use convolutional layers for generating realistic images and textures. For language generation tasks, recurrent neural networks (RNNs), including variants such as long short-term memory (LSTM) networks and gated recurrent units (GRUs), have historically been employed to generate sequential data by predicting the likelihood of each word based on preceding context. More recently, transformer-based architectures have become prevalent for natural language processing and generation, as they can effectively attend to various parts of input sequences and learn complex dependencies to produce coherent and contextually relevant text. The generative AI models described herein can be trained on diverse types of training data, including text, images, and audio, and can be applied to a variety of applications such as image and video synthesis, natural language generation, music composition, code generation, and other content creation tasks.

In the present disclosure, data used to train a machine learning model can include data containing correlations that a machine learning process or technique may utilize to model relationships between two or more types or categories of data elements (“training data”). For example, and without limitation, the training data may comprise a plurality of data entries, each entry representing a set of data elements that were recorded, received, and/or generated together. The data elements may be correlated by shared co-occurrence within a data entry, proximity within the data, or other relationships. Multiple data entries within the training data may exhibit one or more trends or patterns in correlations between categories or types of data elements. For instance, and without limitation, a higher value of a first data element belonging to a first category or type of data element may tend to correlate with a higher value of a second data element belonging to a second category or type of data element, indicating a possible proportional or other mathematical relationship linking values across categories. Multiple categories of data elements may be related in the training data according to various correlations, which may indicate causative, associative, and/or predictive links between categories of data elements. These correlations may be modeled as mathematical or statistical relationships by the machine learning processes described herein. The training data may be formatted and/or organized by categories of data elements, for example by associating data elements with one or more descriptors corresponding to categories. As a non-limiting example, training data may include data entered in standardized forms by persons or processes, such that entry of a given data element in a given field within a form may be mapped or correlated to one or more category descriptors. Elements in the training data may be linked to descriptors of categories or types by tags, tokens, or other data elements. For example, and without limitation, training data may be provided in fixed-length formats, formats linking positions of data to categories such as comma-separated value (CSV) formats, and/or self-describing formats such as extensible markup language (XML), enabling processes or devices to detect categories of data.

Alternatively, or additionally, the training data may include one or more data elements that are not categorized, that is, the training data may not be formatted or contain descriptors for some elements of data. Machine-learning models or algorithms and/or other processes may sort the training data according to one or more categorizations using, for instance, natural language processing algorithms, tokenization, detection of correlated values in raw data and the like. The categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name or other types of data may be identified by reference to a list, dictionary, or other compendium of terms, permitting ad-hoc categorization by machine-learning algorithms, and/or automated association of data in the data entry with descriptors or into a given format. The ability to categorize data entries automatically may enable the same training data to be made applicable for two or more distinct machine-learning algorithms as described in further detail below. Training data used by an electronic device may correlate any input data as described in this disclosure to any output data as described in this disclosure.

As used herein, the term “data object” can refer to a location or region of storage that contains a collection of attributes or groups of values that function as an aspect, characteristic, quality, entity, or descriptor of the data object. As such, a data object can be a collection of one or more data points that create meaning as a whole. One example of a data object is a data table, but a data object can also be data arrays, pointers, records, files, sets, and scalar type of data.

As used herein, the term “attribute” or “data attribute” is generally intended to mean or refer to the characteristic, properties or data that describes as aspect of a data object or other data. The attribute can hence refer to a quality or characteristic that defines a person, group, or data objects. The properties can define the type of data entity. The attributes can include a naming attribute, a descriptive attribute, and/or a referential attribute. The naming attribute can name an instance of a data object. The descriptive attribute can be used to describe the characteristics or features or the relationship with the data object. The referential attribute can be used to formalize binary and associative relationships and in referring to another instance of the attribute or data object stored at another location (e.g., in another table). When used in connection with prompts for use with a generative language model, the term is further defined below.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “electronic device” can include servers, controllers, processors, computers, tablets, storage devices, databases, memory elements and the like.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A system for monitoring an axial biasing force applied to a packing assembly having a plurality of packing elements mounted within stationary equipment, comprising
a packing loading assembly for sealing a process fluid within the stationary equipment and for applying the axial biasing force to the packing assembly via a pressurized fluid from a fluid source, wherein the packing loading assembly includes
a gland element for coupling to the stationary equipment, and
an external actuation subsystem for applying an axial actuation force directly to the gland element in response to the pressurized fluid, and wherein the gland element in response to the axial actuation force applies the axial biasing force to the packing assembly, wherein the external actuation subsystem has a stationary component and a movable component coupled to the gland element, and
a sensor assembly having a position sensor coupled to the external actuation subsystem for monitoring movement of the movable component relative to the stationary component.

2. The system of claim 1, wherein the position sensor measures a relative movement between the stationary component and the movable component and generates in response thereto sensor data indicative of a physical state, position, or movement of one or more packing elements of the packing assembly.

3. The system of claim 2, wherein the sensor data includes packing related data.

4. The system of claim 3, wherein the packing related data is correlated to an amount of compression applied to the packing assembly.

5. The system of claim 3, wherein the packing related is correlated to an amount of compression remaining to be applied to the packing assembly or a remaining amount of useful life in the packing assembly.

6. The system of claim 3, wherein the sensor assembly further comprises a main housing having a first main housing component and a second main housing component, wherein at least one of the first and second main housing components can move axially relative to the other.

7. The system of claim 6, wherein the first main housing component has an open end forming a first chamber and an opposed closed end, and wherein the second main housing component forms a second chamber for mounting the position sensor.

8. The system of claim 7, wherein the second main housing component is sized and configured to seat within a portion of the first chamber, and the first main housing component moves axially relative to the second main housing component in a telescoping manner.

9. The system of claim 8, wherein the second main housing component has a first groove formed in an outer surface for seating a first sealing element, wherein the first sealing element forms a seal between an inner surface of the first main housing component and the outer surface of the second main housing component.

10. The system of claim 8, wherein the position sensor comprises a time-of-flight (TOF) sensor configured to generate and emit a radiation beam.

11. The system of claim 10, wherein the closed end of the first main housing component has disposed therein an optical element formed of an optically transmissive material for reflecting back the radiation beam to form a reflected beam, wherein the TOF sensor detects the reflected beam which forms part of the sensor data.

12. The system of claim 11, wherein the second end of the first main housing component has an air vent formed therein that communicates with the first chamber.

13. The system of claim 12, further comprising a securing assembly for securing the sensor assembly to the external actuation subsystem, wherein the securing assembly includes a first bracket element for coupling the first main housing component to the movable component of the external actuation subsystem, and a second bracket element for coupling the second main housing component to the stationary component of the external actuation subsystem.

14. The system of claim 11, further comprising a protective optical element disposed adjacent to the position sensor to provide optical conditioning and environmental protection to the position sensor.

15. The system of claim 14, wherein the protective optical element is formed from or is coated with polytetrafluoroethylene (PTFE) configured to provide diffuse reflection characteristics.

16. The system of claim 11, wherein the sensor data includes one or more of an absolute distance measurement between the position sensor and a target surface of the first chamber, incremental displacement values of the first main housing component, direction of movement of the first main housing component, a rate of position change over time of the first main housing component, a signal strength, a timestamp, and temperature within the second chamber.

17. The system of claim 16, further comprising an electronic device in communication with the position sensor, the electronic device comprising a processor configured to:
receive the sensor data from the position sensor;
determine a compression state of the packing elements based on the sensor data;
determine a remaining compression capacity of the packing elements based on the sensor data; and
generate an output indicative of at least one of the compression state and the remaining compression capacity.

18. The system of claim 16, further comprising an electronic device having a storage element for storing one or more control applications and a processor for processing the sensor data and for applying thereto the control application to determine one or more parameters associated with the packing assembly.

19. The system of claim 17, wherein the electronic device is configured to generate a user interface displaying at least one of a current compression value, a remaining adjustment capacity, and a predicted time to replacement of the packing elements.

20. The system of claim 1, wherein the gland element comprises a top portion having a top surface for contacting a bottom surface of the external actuation subsystem and a bottom flange portion that has a surface that contacts an axially outermost one of the packing elements for applying the axial biasing force thereto.

21. A method of monitoring and predicting maintenance requirements for a packing loading assembly having a plurality of packing elements and a movable component configured to apply compression to the plurality of packing elements, the method comprising:
coupling a sensor assembly to the packing loading assembly, wherein the sensor assembly includes a position sensor configured to measure a position of the movable component relative to a stationary reference;
generating sensor data with the position sensor over time, the sensor data being indicative of progressive movement of the movable component;
transmitting the sensor data to an electronic device;
processing the sensor data with the electronic device to determine a current compression state of the packing elements and a remaining compression capacity;
analyzing historical sensor data with a machine learning model model to estimate a remaining useful life of the packing elements; and
generating a maintenance output indicating at least one of: the current compression state, the remaining compression capacity, and the estimated remaining useful life.

22. The method of claim 21, wherein analyzing the historical sensor data comprises applying the machine learning model to extrapolate a compression-versus-time relationship and to predict a future time at which a maximum compression limit is reached.

23. The method of claim 21, wherein analyzing the historical sensor data comprises applying a reliability engineering model to estimate a time-dependent hazard rate for the packing elements.

24. The method of claim 21, further comprising generating an alert when at least one of the remaining compression capacity and the estimated remaining useful life falls below a predetermined threshold.

25. A sensor assembly for monitoring a packing loading assembly having packing elements and a loading component movable between a preloaded position and a loaded position to apply compression to the packing elements, the sensor assembly comprising:
a first main housing component coupled to the loading component and configured to move with the loading component;
a second main housing component coupled to a stationary reference and configured to remain stationary relative to the loading component, wherein the first main housing component and the second main housing component are configured for telescoping movement relative to each other along an axial direction;
a position sensor mounted within the second housing component and configured to measure a distance to a target surface associated with the first housing component; and
a securing assembly configured to attach the first housing component to the loading component and to attach the second housing component to the stationary reference.

26. The sensor assembly of claim 25, wherein the position sensor comprises an optical time-of-flight (TOF) sensor configured to emit an optical signal toward the target surface and to determine the distance based on a propagation time of a radiation beam generated by the TOF sensor.

27. The sensor assembly of claim 26, wherein the target surface includes an optical element positioned at an end of the first housing component and configured to reflect the radiation beam emitted by the position sensor.

28. The sensor assembly of claim 27, wherein the optical element comprises polytetrafluoroethylene (PTFE) configured to provide diffuse reflection characteristics.

29. The sensor assembly of claim 28, wherein the first main housing component has a chamber and the second housing component is configured to slide telescopically within the chamber of the first housing component.

30. The sensor assembly of claim 29, further comprising one or more sealing elements disposed between the first main housing component and the second housing component to form a seal therebetween.

31. The sensor assembly of claim 30, further comprising an air vent formed in the first housing component and configured to allow air to enter and exit the chamber during relative movement of the first and second main housing components.
